(19) United States
(12) Patent Application Publication
(10) Pub. No.: US 2020/0052921 A1
(43) Pub. Date: Feb. 13, 2020

(54) COLLABORATIVE COMMUNICATIONS ENVIRONMENT WITH PARTICIPANT FLEXIBILITY

(71) Applicant: RingCentral, Inc., Belmont, CA (US)

(72) Inventor: Christopher van Rensburg, Foster City, CA (US)

(73) Assignee: RingCentral, Inc.

(21) Appl. No.: 16/058,186

(22) Filed: Aug. 8, 2018

(51) Int. Cl. H04L 12/18; H04L 12/58; G06N 99/00

(52) U.S. Cl. CPC H04L 12/1822; H04L 51/04; G06F 3/04817; G06N 99/005; H04L 12/1818

(57) ABSTRACT

A method includes receiving a user electronic input. The user electronic input is selected from a group consisting of logical rules, queries, and a subject matter. A degree of flexibility that is associated with the user electronic input is received from a user. Participants within an organization are identified based on the received user electronic input and further based on the degree of flexibility. An electronic chat room that includes at least a subset of the identified participants is created.

### TECHNICAL FIELD

The present disclosure relates generally to the field of computer supported collaborative communications environments between a number of participants. More specifically, and without limitation, this disclosure relates to systems and methods for automatically selecting participants of online chat conversations in collaborative communications environments through means other than a contact list.

### BACKGROUND

Online collaborative communications environments such as online chat between various entities and/or individual participants within the same organization and/or different organizations has increased with advent of the Internet. For example, online chat may allow participants and collaborators to discuss topics, projects, initiatives, etc. in one or more chat conversations. Typically, the chat organizer or administrator may create an online chat by selecting individual chat participants from a contact list. Alternatively, online chat may be a public forum open to any participant to join. In other words, the online chat organizer is typically required to explicitly populate the chat participants, requiring the administrator to know who needs to be invited. Managing the participants for online chat is challenging and time consuming for the chat organizer, especially in big organizations. For example, the chat organizer may omit to add a participant or may add participants that should not be added. Moreover, maintaining the appropriate participants of an online chat is also time consuming and very difficult to achieve in big organizations. For example, organizations change over time as they grow and evolve. As a result, the participants of each team may be changed as new participants join (from either within the organization or outside of the organization) or as participants depart (from either within the organization or outside of the organization), or as the project and/or the scope of collaboration changes over time as the roadmap for products changes. Furthermore, as changes to the participants of online, e.g., online chat, etc., are made, the institutional knowledge is often lost.

### SUMMARY

According to some example embodiments, a method includes receiving a user electronic input. The user electronic input is selected from a group consisting of logical rules, queries, and a subject matter. A degree of flexibility that is associated with the user electronic input is received from a user. Participants within an organization are identified based on the received user electronic input and further based on the degree of flexibility. It is appreciated that machine learning and artificial intelligence may also be utilized to identify the participants. It is further appreciated that the identifying of the participants may be based on participants of the organization's past projects, expertise, educational degree, department within the organization, title, and interest. An electronic chat room that includes at least a subset of the identified participants is created.

In some embodiments, the method further includes updating the identified participants within the organization over time and further updating the participants of the subset of the identified participants of the electronic chat room. According to an example in accordance with some embodiments, the updating is responsive to content of conversation within the electronic chat room. In some embodiments, the identified participants within the organization are updated over time. The updating may be responsive to changes within the organization. The changes may be due to changes to title, changes to projects, and changes to participants of a group within the organization. In some embodiments, the participants of the subset of the identified participants may be updated, e.g., automatically, responsive to the changes. In some other embodiments, the participants of the subset of identified participants may be updated responsive to user selection thereof.

According to some embodiments, a method includes receiving a user electronic input. The user electronic input may be logical rules, queries, a subject matter, etc. Participants within an organization are identified based on the received user electronic input. It is appreciated that machine learning and artificial intelligence may also be utilized to identify the participants. It is further appreciated that the identifying of the participants may be based on participants of the organization's past projects, expertise, educational degree, department within the organization, title, and interest. An electronic chat room that includes at least a subset of the identified participants is created.

In some embodiments, the method further includes updating the identified participants within the organization over time and further updating the participants of the subset of the identified participants of the electronic chat room. According to an example in accordance with some embodiments, the updating is responsive to content of conversation within the electronic chat room. In some embodiments, the identified participants within the organization are updated over time. The updating may be responsive to changes within the organization. The changes may be due to changes to title, changes to projects, and changes to participants of a group within the organization. In some embodiments, the participants of the subset of the identified participants may be updated, e.g., automatically or responsive to user selection thereof, responsive to the changes.

These and other features and aspects of the concepts described herein may be better understood with reference to the following drawings, description, and appended claims.

### BRIEF DESCRIPTION OF DRAWINGS

FIGS. 1A-1L are diagrams showing examples of GUIs associated with creation of an online chat based on subject matter according to some embodiments.

FIGS. 2A-2K are diagrams illustrating examples of GUIs associated with creation of an online chat based on a query according to some embodiments.

FIGS. 3A-3K are diagrams show examples of GUIs associated with creation of an online chat based on logical expressions according to some embodiments.

FIG. 4 is a flow chart illustrating an example of method flow for creating online chats in accordance with some embodiments.

FIG. 5 is another flow chart illustrating an example of method flow for creating online chats in accordance with some embodiments.

FIG. 6 is a block diagram depicting an example of computer system suitable for creating online chats in accordance with some embodiments.

### DETAILED DESCRIPTION

The example embodiments herein are directed to creating online collaborative teams, e.g., online chat, and to maintain the online collaborative teams automatically, without having to exclusively rely on explicit selection of the chat participants, e.g., from a contact list. Moreover, the example embodiments are directed to creating online collaborative teams, e.g., online chats, based on logical expressions, queries, subject matter, etc., without requiring selection of the participants individually and from a contact list, as an example. However, it is appreciated that the creation of collaborative teams may be complemented with selection of participants from a contact list. Additionally, the example embodiments described in this disclosure are directed to creating online collaborative teams where each parameter used to create the online chat may have a flexibility associated therewith. The flexibility can be controlled by the collaborative team organizer or administrator, e.g., online chat organizer or administrator, to capture more participants by increasing the flexibility and to capture fewer participants by decreasing the flexibility as explained by example embodiments herein.

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “rendering”, “utilizing”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

It is appreciated that throughout the application online collaborative team creation and management may be referred to as online chat, online chat room, or chat conversation creation and management but references to the foregoing should not be construed as limiting the scope of the example embodiments as they are referenced merely for illustrative purposes. As understood by those skilled in the art, online collaborative communications environments and team creation and management such as Glip®, RingCentral Meetings™ for audio or video conferencing, WebEx®, Skype®, Microsoft Teams™, Google Hangouts™, or the like, with or without combination with additional applications, may be used to implement some of the embodiments of the present disclosure.

In some example embodiments, a method includes receiving a user electronic input. The user electronic input may be logical rules, queries, and/or a subject matter. The method may further include receiving a degree of flexibility from a user that is associated with the user electronic input. Participants within an organization are identified based on the received user electronic input and further based on the degree of flexibility. An electronic chat room is created that includes at least a subset of the identified participants.

Accordingly, online chats may be created by a processor where the participants are identified and subsequently selected. Participant selection may be done either by the administrator or by the system automatically, based on queries, logical expressions, and/or subject matter. As a result, selection of the participants to be invited to participate in a collaborative environment does not only occur from a contact list. In other words, explicit selection of the participants, e.g., from a contact list, can be complemented using an automated system that identifies additional participants. In some embodiments, an online chat is created and its participants are identified without requiring explicit selection of the participants from a contact list. Furthermore, the participants of the online chat can be automatically maintained and managed over time. For example, queries, logical expressions, and/or subject matter can be received via a graphical user interface (GUI) by a processor. The processor may utilize the received data and resolve the request against a database storing employee information such as tasks, events, files, links, employment history, resume, title, subject matter expertise, interests, prior online chats, previous projects, current projects, organizational chart, company's products that the participant is associated with or in some examples the company's products that the participant is not associated with, employee's social media, and the like to create online chats. It is appreciated that machine learning and artificial intelligence may be used in identifying the appropriate participants of online chats where the participants are automatically selected by the system or presented, e.g., using a display device on a GUI, to the online chat organizer or administrator for selection thereof.

According to an example embodiment, a system including a processor may receive certain information, e.g., queries, logical expressions, subject matter, etc., from the online chat organizer or administrator via a GUI. The received information may be accompanied with a request to create an online chat, or the received information itself may be treated as a request to create an online chat. The received information may be complemented or resolved against a database storing information associated with participants from an organization such as employees within a company. The database may include information such as tasks, events, files, links, employment history, resume, title, age, subject matter expertise, interests, prior online chats, previous projects, current projects, organizational chart, company's products, employee's social media, and/or the like associated with the participants. The information may be transmitted from one or more storage devices via one or more interfaces (e.g., via Integrated Drive Electronics (IDE), Serial AT Attachment (SATA), Small Computer System Interface (SCSI), Serial SCSI, Universal System Bus (USB), or the like) of a database or over one or more networks (e.g., the Internet, Local Area Network (LAN), Wi-Fi, 4G, or the like) to the processor.

It is appreciated that the system may further derive additional information from the received data using machine learning and artificial intelligence. It is appreciated that any information transmitted between the administrator or online chat organizer, and the system, may be over one or more networks. According to an example embodiment, a processor may automatically convert one or more of the received information to one or more chat conversations by identifying and including the appropriate participants of the online chat. In some embodiments, the processor may be seeded with a learning library or construct a learning library on-the-fly which then allows for the algorithm (and/or the library) to be updated each time it is used. Other machine learning approaches are also possible. For example, neural networks, Bayesian networks, deep learning, or the like may be used in identification of chat participants and selection thereof and/or presentation to the administrator for selection thereof. In some examples, the system may use machine learning to rank the confidence of each temporal flow or logical flow based on training from a learning library. In further examples, the machine learning algorithm may incorporate input from the users associated with a temporal flow or logical flow to add temporal flows or logical flows that users rank as accurate to the learning library.

The processor may automatically add one or more of the participants to the chat conversation based on the received information, e.g., queries, logical rules, subject matter, etc. and/or based on the derived information therefrom through various means, e.g., machine learning, artificial intelligence. In some embodiments, the identified participants are presented to the user for user selection thereof. It is appreciated that in some example embodiments, the system may present or automatically add participants as described herein in addition to manual selection of additional participants to be added from a contact list. In other example embodiments, the processor may create an online chat, and notify one or more of the participants of the chat conversation and request a response. For example, the processor may add a participant to the chat conversation and send an invitation to the remaining participants asking them to join the chat conversation. In this example, the remaining participants may either accept the invite and be added to the chat conversation or reject the invite and not be added to the chat conversation or they may delegate the invite to someone else.

According to some embodiments, the processor populates an initial content of the online chat conversation with at least a portion of content based on the subject matter, query, logical rules, title of the online chat, etc. It is appreciated that the administrator or the online chat organizer may provide one or more documents, e.g., white paper, files, link, picture, source code, etc. where that information or a portion thereof can be populated in the online chat. It is appreciated that online chat and content thereof may be rendered by the processor or graphics unit on a display device, e.g., liquid crystal display (LCD), etc.

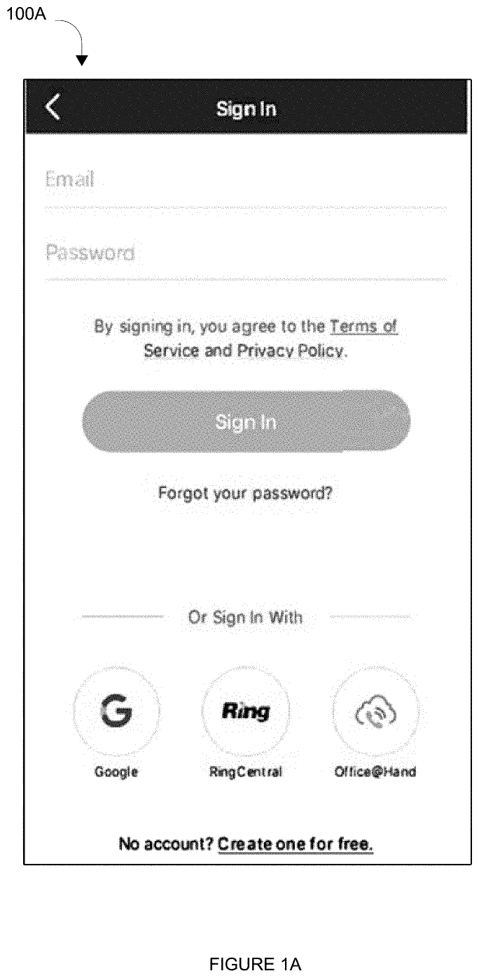

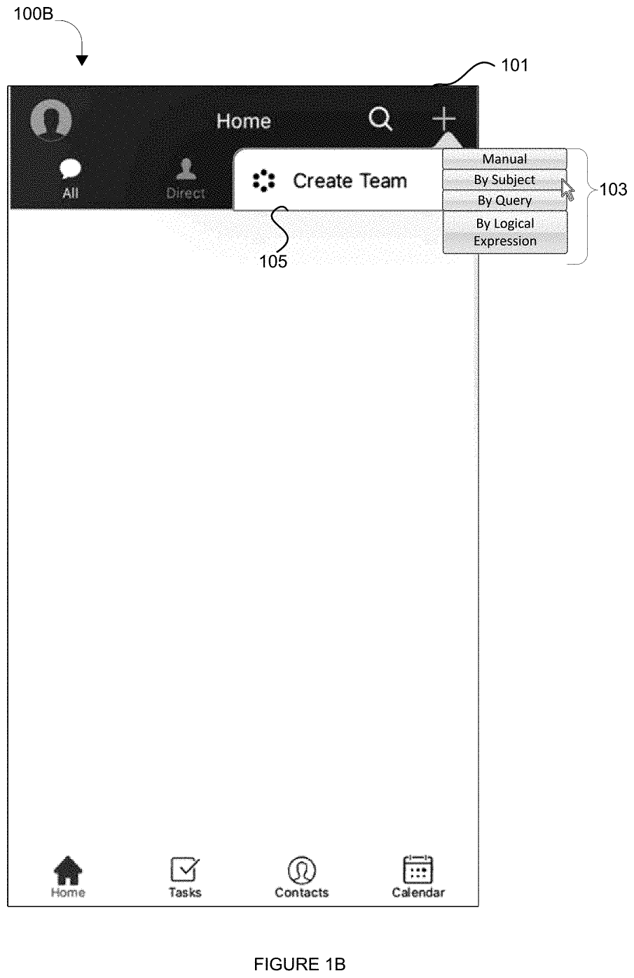

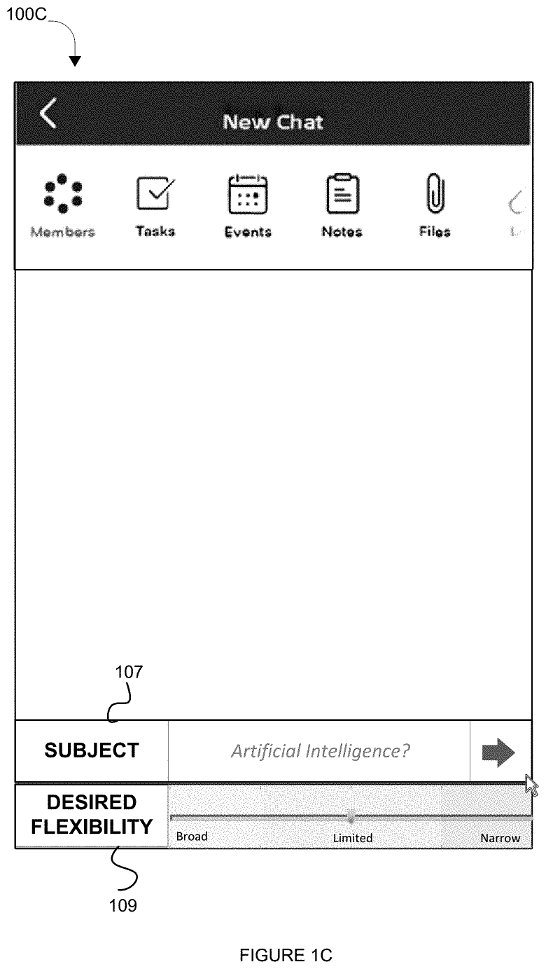

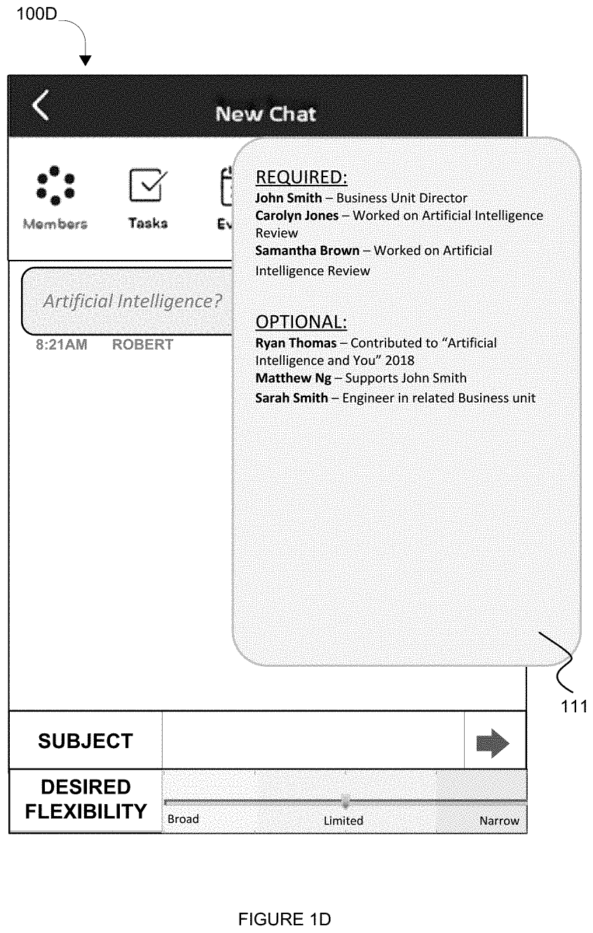

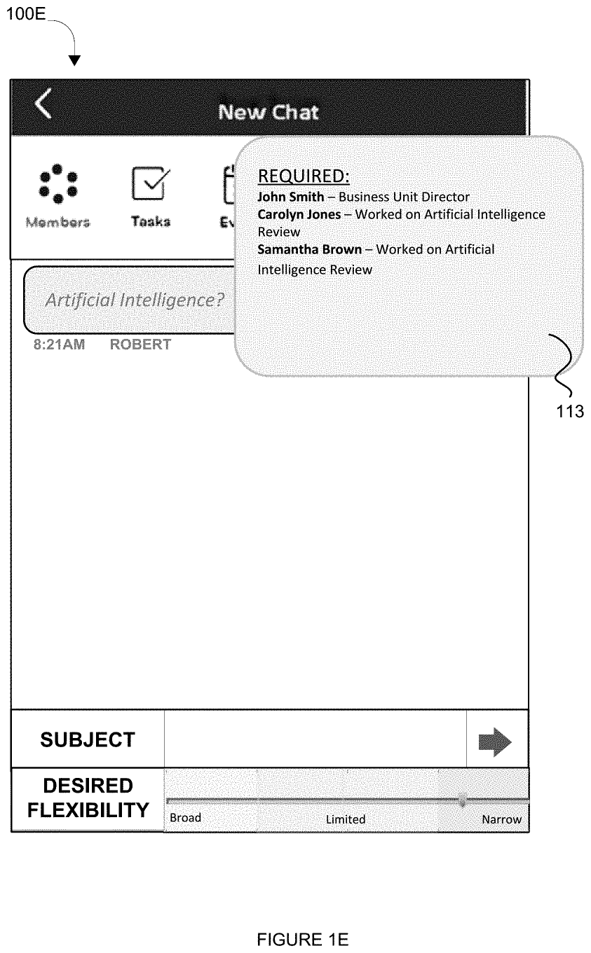

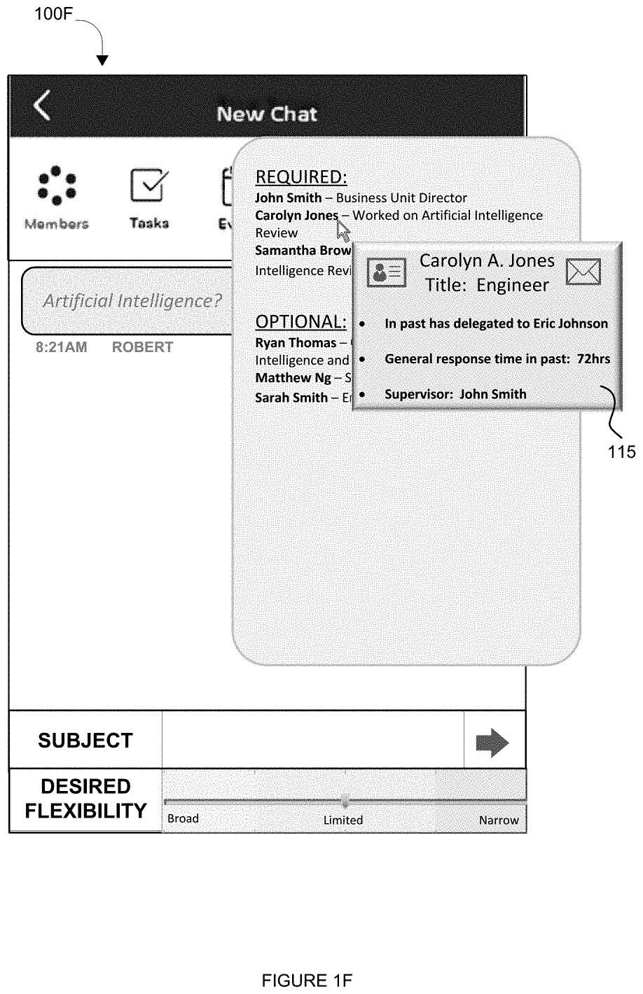

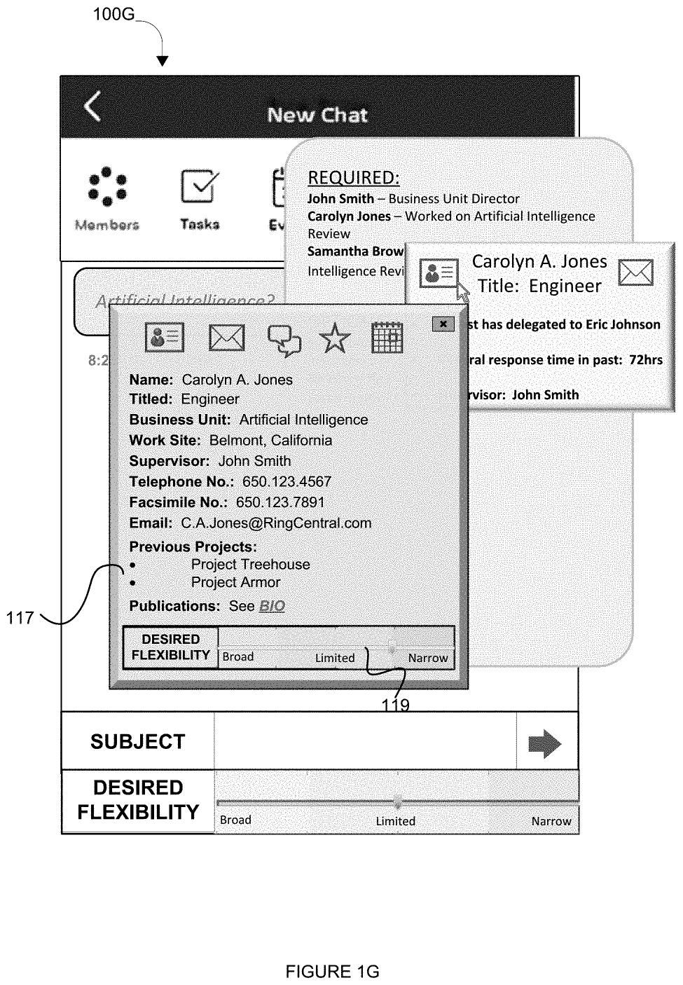

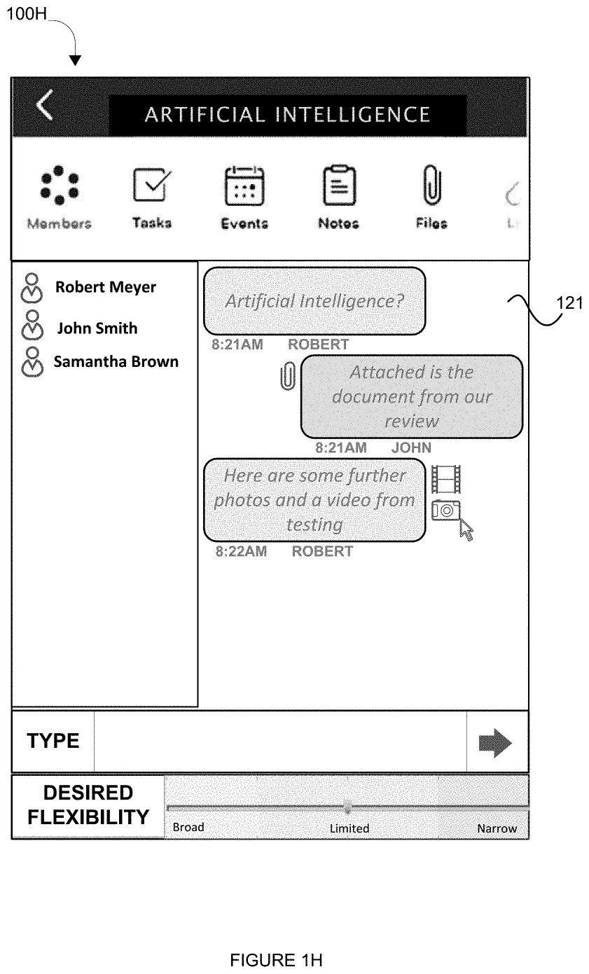

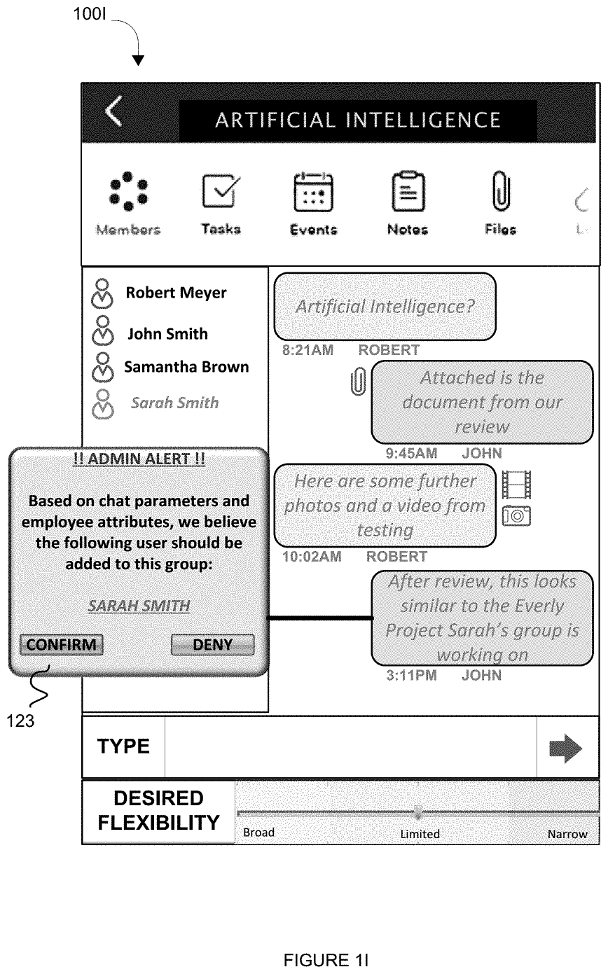

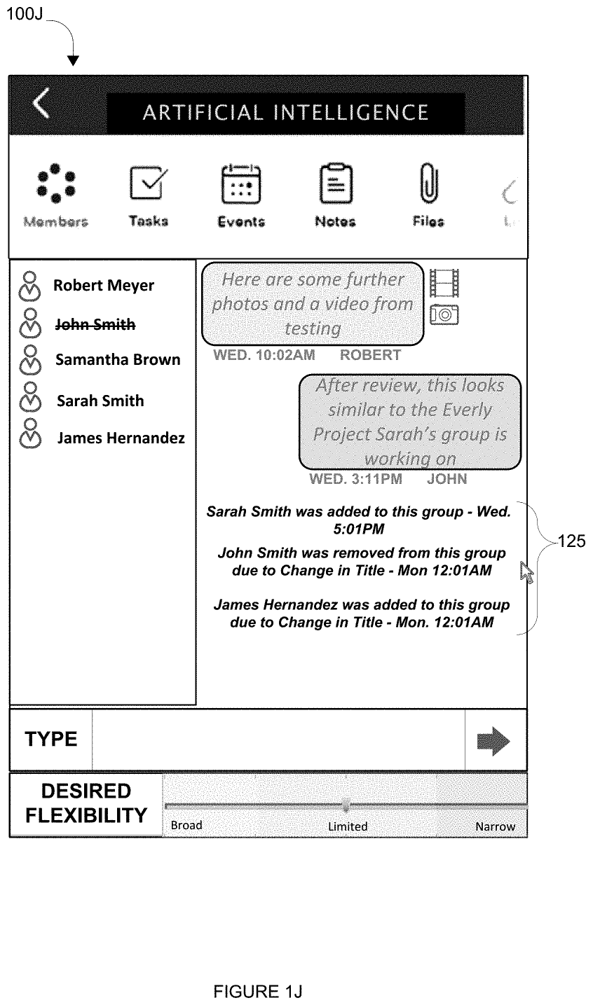

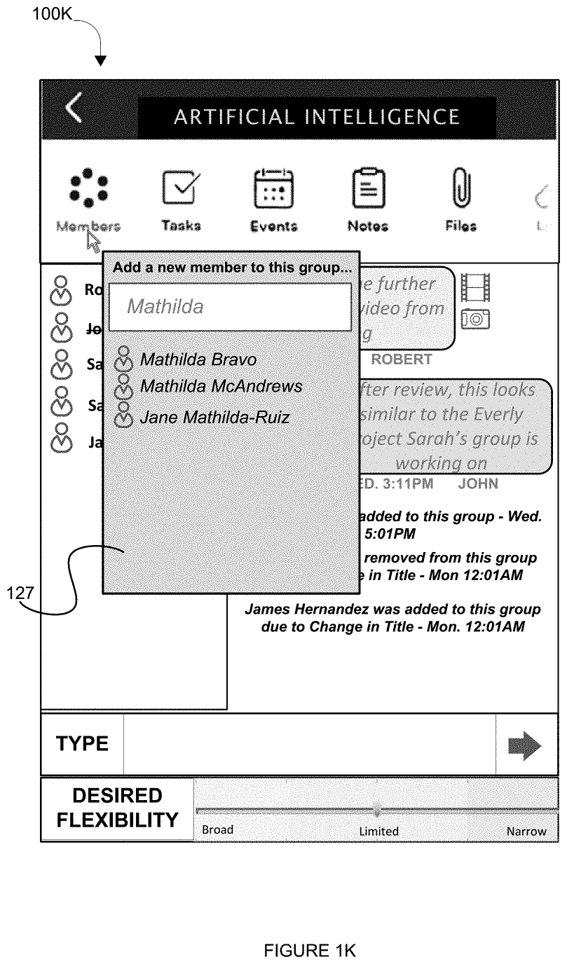

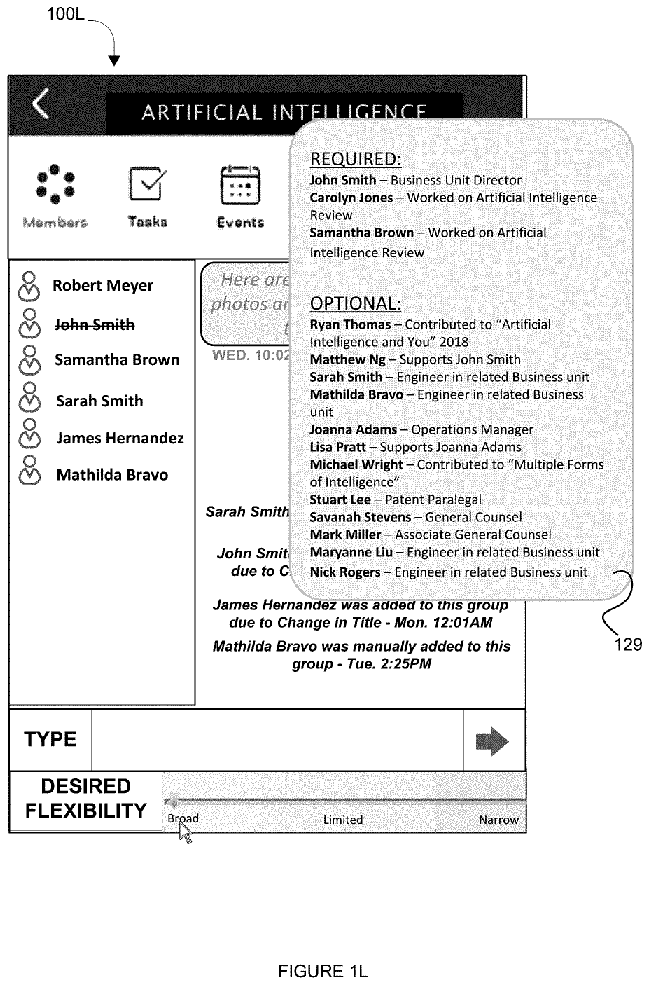

FIGS. 1A-1L are diagrams which show examples of GUIs associated with creation of an online chat based on subject matter according to some embodiments. The processor receives information from an online chat organizer or administrator using one or more GUIs and create an online chat room. FIG. 1A shows a diagram of an example of a GUI 100A in accordance with some embodiments. The administrator or online chat organizer login with their credentials. It is appreciated that GUI 100A may be optional. For example, GUI 100A may not be needed when the organizer is logged into the system already to access their email accounts, as an example. It is appreciated that in some embodiments the organizer may login using credentials from a Google™ account, a RingCentral® account, etc. Once the information received via the GUI 100A is verified by a processor, an organizer may be granted access to create online chats.

FIG. 1B shows a diagram of an example of GUI 100B in accordance with some embodiments for creating online chats. As shown by GUI 100B, online chat organizer or administrator selects the “+” icon 101 in order to create online chat teams. Selection of the “+” icon 101 or hovering over it presents a dropdown menu 103 to the organizer. In this instance “Create Team” icon 105 is displayed and selection and/or hovering over the “Create Team” icon 105 presents additional icons for selection by the organizer. For example, selection of “Manual” icon enables the team to be created and for participants to be selected explicitly from a contact list. Additionally, online chat is created by selecting “By Subject” icon where the organizer can type a subject matter of interest, e.g., artificial intelligence (AI), machine learning, etc. Based on the subject matter, the system, e.g., processor, can resolve that information against a database storing information regarding potential participants, e.g., employees of an organization, and to add the appropriate participants automatically and/or present them to the organizer for selection thereof. According to some embodiments, the processor compares the received information through the GUIs to a database storing one or more information regarding the employees of the organization, e.g., employment history, previous online chats, current projects, past projects, current product associated with the employee, title, technical background, degree, location, interests, title and/or subject matter of previous meetings, emails, tasks, events, files, links, resume, expertise, prior online chats, organizational chart associated with the employee and his position within the company, company's products associated with the employee, employees social media, texts, contact list, employee's behavior (e.g., responsiveness, delegation of tasks, rating from peers, etc.), or the like.

In some embodiments, a team is created by selecting a “By Query” icon where the organizer types a query (i.e. freeform expression), e.g., typing a sentence, any free form expression such as freeform expression used in a search engine, etc. The query may be resolved by the system, e.g., processor, against a database storing information regarding potential participants, e.g., employees of an organization, and to add the appropriate participants automatically and/or present them to the organizer for selection thereof. According to some embodiments, the processor may compare the received information through the GUIs to a database storing information regarding the employees of the organization, e.g., employment history, previous online chats, current projects, past projects, current product associated with the employee, title, technical background, degree, location, interests, title and/or subject matter of previous meetings, emails, tasks, events, files, links, resume, expertise, prior online chats, organizational chart associated with the employee and his position within the company, company's products associated with the employee, employees social media, texts, contact list, employee's behavior (e.g., responsiveness, delegation of tasks, rating from peers, etc.), and/or the like. It is appreciated that information regarding potential participants, as presented above is referred to as participants' attributes throughout the instant application.

In some embodiments, a team may be created by selecting a “By Logical Expression” icon where the organizer can type a logical rule, formulas, etc., e.g., (Location=Belmont AND Background=AI), etc. The logical expression may be resolved by the system, e.g., processor, against a database storing information regarding potential participants' attributes.

It is appreciated that creating an online chat may also occur based on a selection of a combination of the above icons. For example, in some embodiments participants are invited via a contact list in addition to by subject matter. In some of the embodiments an online chat is created by selecting the subject matter icon as well as by conducting a query.

FIG. 1C shows a diagram depicting an example of a GUI 100C where an online chat is created using a subject matter. In this example, the GUI 100C enables the organizer to enter a subject 107, e.g., Artificial Intelligence. It is appreciated that the subject may be the subject of the online chat that will be published and/or its subject matter, which may or may not necessarily be its name. A processor receives the subject matter of the online chat via the GUI 100C. The received subject matter is resolved by the processor against a database as described above. In some embodiments, the online chat is accompanied by selection of participants, tasks, events, notes, files, etc. as displayed on top of the screen. In some embodiments, flexibility scale (hereinafter referred to and displayed as “Desired Flexibility”) 109 associated with the subject matter is modified. For example, broadening the desired flexibility scale 109, hence increasing it, results in expansion of the subject matter and as a result more results (i.e. participants). On the other hand, narrowing the desired flexibility scale 109, hence decreasing it, results in a more concise identification of the participants, thereby producing fewer results. In some embodiments, the flexibility scale 109 may be selected as “limited” by default, which is neither narrow nor broad. In some embodiments, the system makes a decision regarding the parameters to consider when the flexibility scale is changed from broad to narrow and vice versa. It is appreciated that a more narrow scope would only look for direct hits on “AI” whereas more flexible can also provide hits in areas related to “AI” that are not direct hit.

FIG. 1D shows a diagram illustrating an example of a GUI 100D where results 111, as determined by the processor, are rendered on a display device. In the presently described example embodiments, the processor has resolved the subject matter of the online chat, in this instance “Artificial Intelligence” 107, with a Limited flexibility against a database. Flexibility scale can be coupled with ranking rate for each of the options with which the chat was created. For example, when a chat is created with the subject matter AI, the system will search for all participants related to the subject matter. It may have a ranking table with 5 columns containing “education specialization”, “background experience”, “work experience”, “past & present projects” and “hobbies”. When flexibility scale is in middle position the system searches for participants with 3 “yes”. When broadening the flexibility scale the system searches all participants with one “yes”, and when narrowing the flexibility scale only participants with all 5 “yes” are shown in the results. In other embodiments each of the plurality of columns may be ranked with “importance” value, for example columns “work experience” and “past & present projects” can be ranked with high importance “education specialization” and “background experience” with middle importance and “hobbies” with low importance. For each position of the flexibility scale the system can search for participants relevant to the subject matter including “importance” value. When the flexibility scale is in the middle position it can search for participants with 3 “yes” only, with “yes” related to columns with middle and/or high “importance”. When broadening the flexibility scale it is possible for participants with “yes” ranked with low “importance” to be shown in the results. When narrowing the flexibility scale the system may show only participants with 4 “yes” but ranked as middle and high importance or can show only participants with 2 “yes” ranked with high “importance”.

The processor may display the results. For example, in some GUIs “Required” participants and “Optional” participants are displayed. In this example, the “Required” participants are John Smith based on his title (Business Unit Director), Carolyn Jones based on her past work (Worked on Artificial Intelligence Review), and Samantha Brown based on her past work (Worked on Artificial Intelligence Review). In this example, the “Optional” participants are Ryan Thomas based on his contribution, e.g., to some prior online chat or published paper (Contributed to “Artificial Intelligence and You” 2018), Mathew Ng based on his support role (Supports John Smith), and Sarah Smith based on her experience (Engineer in related Business unit). It is appreciated that the results may be displayed for the organizer selection thereof. In some embodiments, the selection may be made automatically by the system. Moreover, it is appreciated that at any point the desired flexibility 109 may be changed in order to broaden or narrow the scope and the results. For example, FIG. 1E shows a diagram of an example of a GUI 100E where the desired flexibility 109 is changed to narrow the scope and as a result fewer participants 113 are suggested. In this example, the optional participants are dropped.

FIG. 1F shows a diagram illustrating an example of a GUI 100F where the desired flexibility 109 is changed to “Limited” and therefore displays the same results as the one shown in FIG. 1D. In this example, hovering or selection of the displayed results provides additional information 115 regarding the potential participants. For example, in this GUI hovering or selecting Carolyn Jones provides additional information 115 such as her title, her supervisor's name, and further information that she has in the past delegated to Eric Johnson and that her general response time is 72 hours. It is appreciated that the information that is provided may be from resolving the information received from the organizer against a database and complementing it with additional information through means such as machine learning, artificial intelligence, etc. For example, in some embodiments, the system suggests Eric Johnson as a participant based on Carolyn Jones' past behavior of delegating to Eric Johnson for subject matters tangentially related to Artificial Intelligence.

FIG. 1G shows a diagram illustrating an example of a GUI 100G where additional information regarding the result is further displayed. In this example, additional information 117 regarding Carolyn Jones is displayed by displaying her business unit, title, work site, supervisor, telephone number, facsimile number, email address, previous projects, publications, etc. It is appreciated that each participant has a desired flexibility scale 119 associated therewith. For example, Carolyn Jones may have desired flexibility 119 associated with her. Thus, narrowing the desired flexibility 119 for Carolyn indicates to the system that she has more of the factors that are desired for the online chat. On the other hand, broadening the desired flexibility 119 for Carolyn indicates to the system that she has fewer of the factors that are desired for the online chat. Thus, the system further provides more potential participants like Carolyn in response to the desired flexibility 119 being broader and vice versa. Similarly, other potential participants, e.g., John Smith, Samantha Brown, etc. also have a desired flexibility associated therewith, where changes to their respective desired flexibility results in more candidates or fewer candidates. In other words, the system enables granularity for the desired flexibility for each parameter, e.g., required participant, optional participant, subject matter, query, logical expression, etc.

FIG. 1H shows a diagram illustrating an example of a GUI 100H where an online chat among the participants, the chat organizer Robert and two other participants John and Samantha, has been created. Conversation 121 among the participants may start and continue. It is appreciated that any information such as a file, a picture, a video clip, etc. may be shared.

According to some embodiments, the processor may set permissions for participants of the team. For example, the processor may set permissions such that some team participants are allowed to replace participants when one participant has left or changed position with a new participant who has taken that participant's place or to add a new participant if it appears that a new employee fits the online chat criteria. Similarly, the processor may set permissions such that some team participants are allowed to add certain kinds of content to the team (e.g., files, links, notes, events, tasks, etc.) while other team participants are not. These permissions may be based on default settings, options received from an organizer initiating creation of the team or from other team participants, or the like.

The formation of a team may allow for exchanging of group messages within the team. The formation of an online chat may allow for tasks and events to be created and distributed to team participants. For example, as used herein, an “event” refers to a title or name associated with an occurrence date (e.g., “Team Meeting” scheduled to occur on May 31, 2016), and a “task” refers to a title or name associated with a due date (e.g., “Legal Memo” due on Jun. 6, 2017). A task or event may be associated with a single participant, with a conversation (that is, a group of messages) between participants, or with a team having a plurality of team participants (also referred to as participants). Furthermore, the formation of an online chat may allow for notes, files, links, etc., to be created and distributed to and/or collaboratively edited by team participants.

It is appreciated that the system, e.g., a processor, may track the chat conversation and manage the participants based on the participant input factors, e.g., logical expressions, queries, subject matter, etc. according to which the chat was created and/or the manner in which the conversation has evolved. For example, FIG. 1I shows a diagram illustrating an example of a GUI 100I that depicts how the system has identified an additional participant 123, e.g., Sarah Smith, to be added, based on the evolution of the conversation. In some embodiments, the participant may be added automatically and in some embodiments the system may present the option of adding the participant to the chat organizer. It is appreciated that the system may similarly determine that a participant is no longer needed and either automatically remove that participant or present the option of removing that participant to the chat organizer or other participants.

It is appreciated that the participants may automatically be managed as the projects and/or products change. In some embodiments, the system tracks the participants of the organization and their behavior and anything related to the participants attributes. Based on those changes, the system proposes a change in participants of the online chat or automatically updates the participants of the online chat. In other words, the participants of the online chat adapts and changes based on the evolution of the organization over time as changes occur to their product line, projects, and goals as well as their employees, their expertise, their background, their experience, etc.

FIG. 1J shows a diagram illustrating an example of GUI 100J that shows changes 125 made to the participants of the online chat based on changes associated with participants as well as non-participants of the online chat. For example, Sarah Smith was added to the group by selecting her, as was suggested in FIG. 1J. John Smith in contrast was removed from the group because of a change in his title and James Hernandez was added due to change in his title.

FIG. 1K shows a diagram illustrating an example of GUI 100K that shows the ability to add new participants by selecting participants from a contact list 127. In other words, selection from a contact list can complement participants that are added through other means, e.g., subject matter, query, logical expression, etc. It is appreciated that new participants, whether added using a contact list or other means, may be added at any time, e.g., at the time of creating the online chat, subsequent to creation of the online chat, subsequent to chats among the online chat participants, etc. It is further appreciated that new participants may be discovered and added by manipulating the desired flexibility. For example, FIG. 1L shows a diagram illustrating an example of GUI 100L that shows the broadening of the desired flexibility 109 according to some embodiments. For example, broadening the desired flexibility may result 129 in more optional participants being presented, as shown.

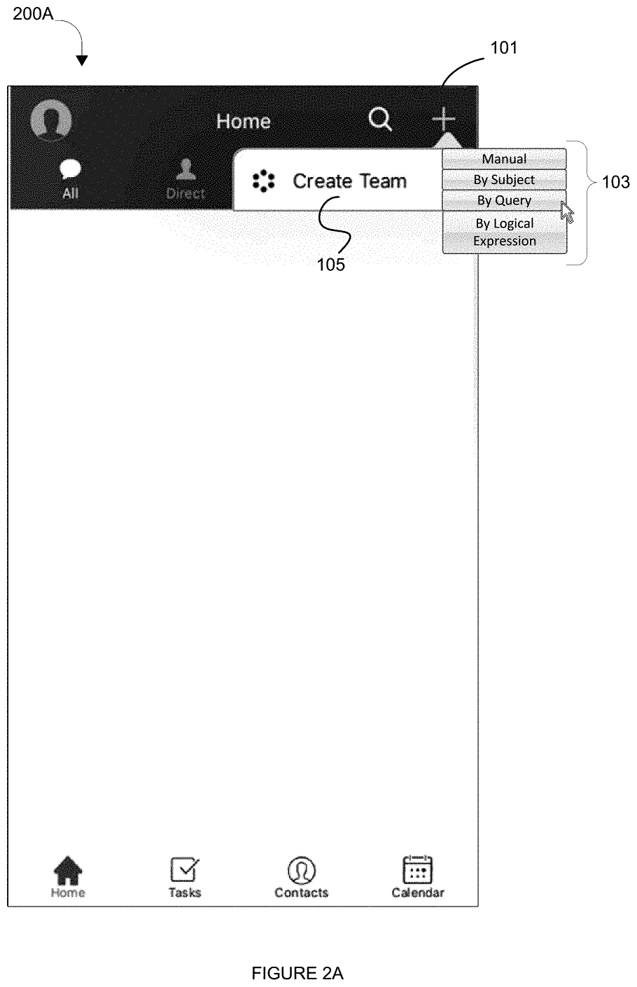

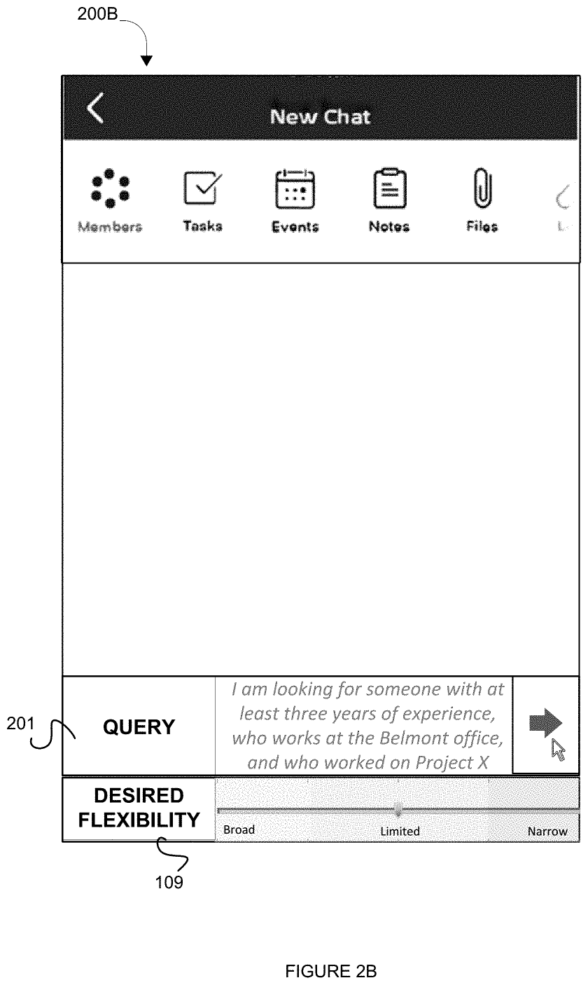

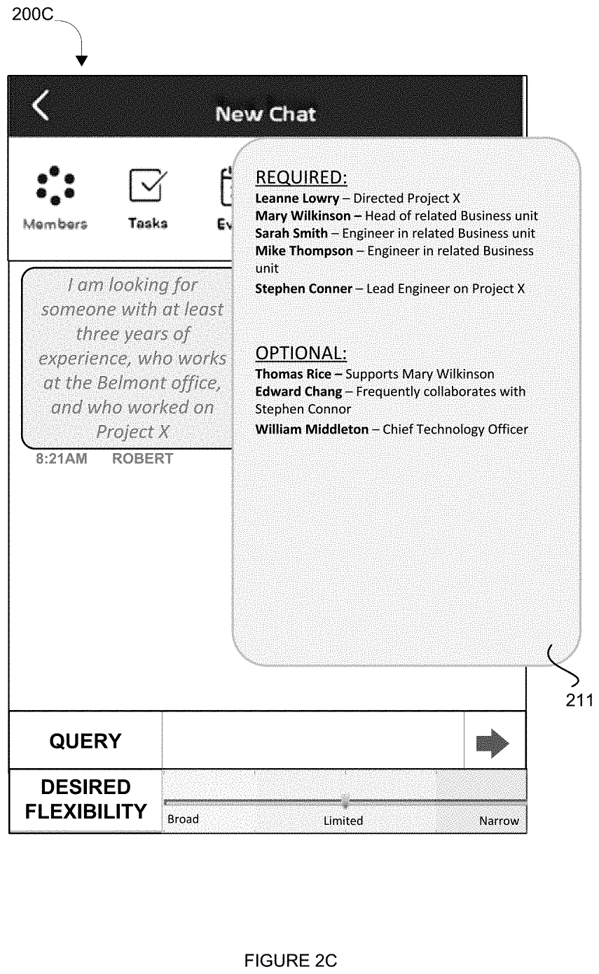

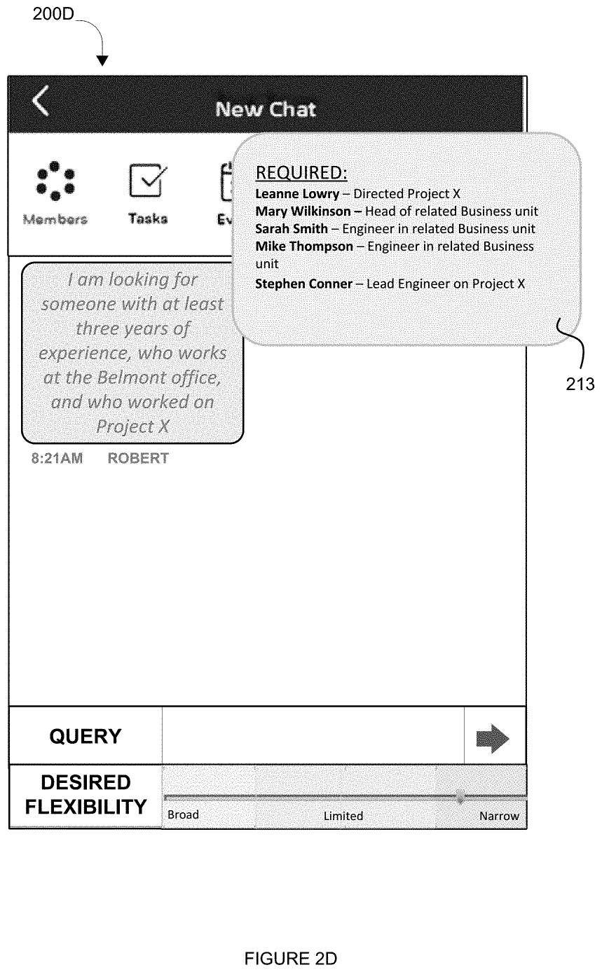

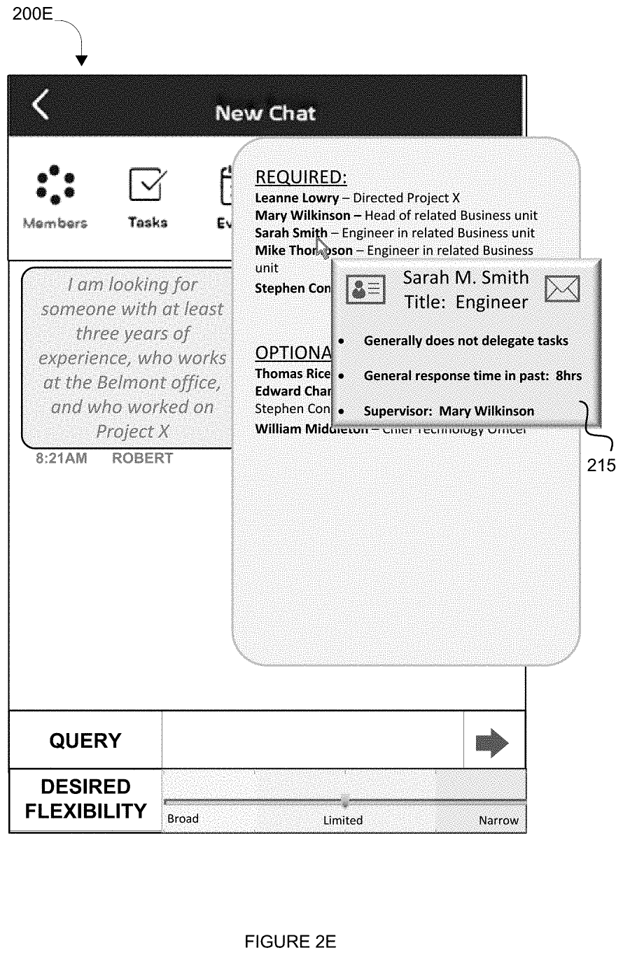

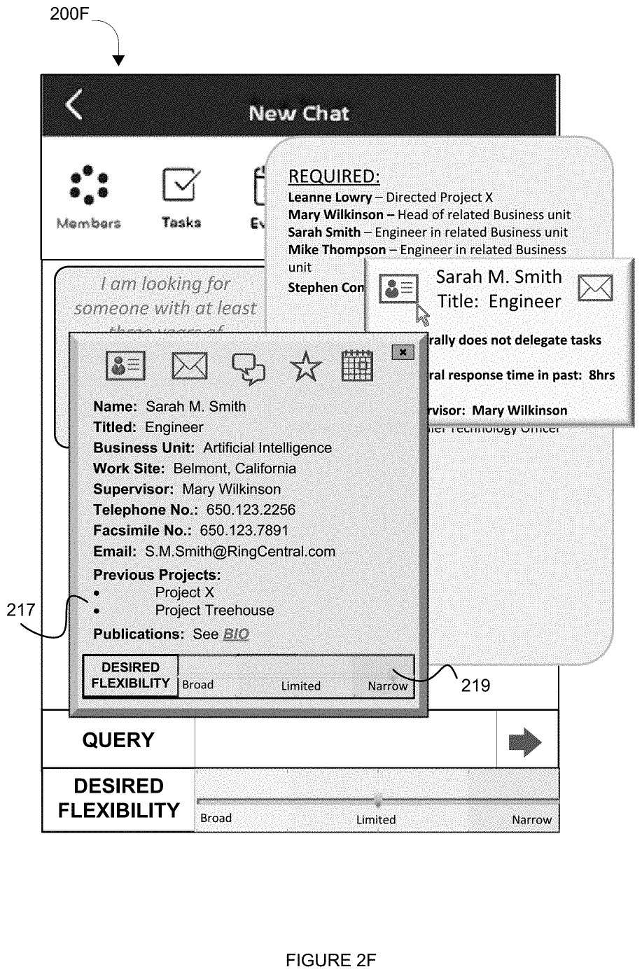

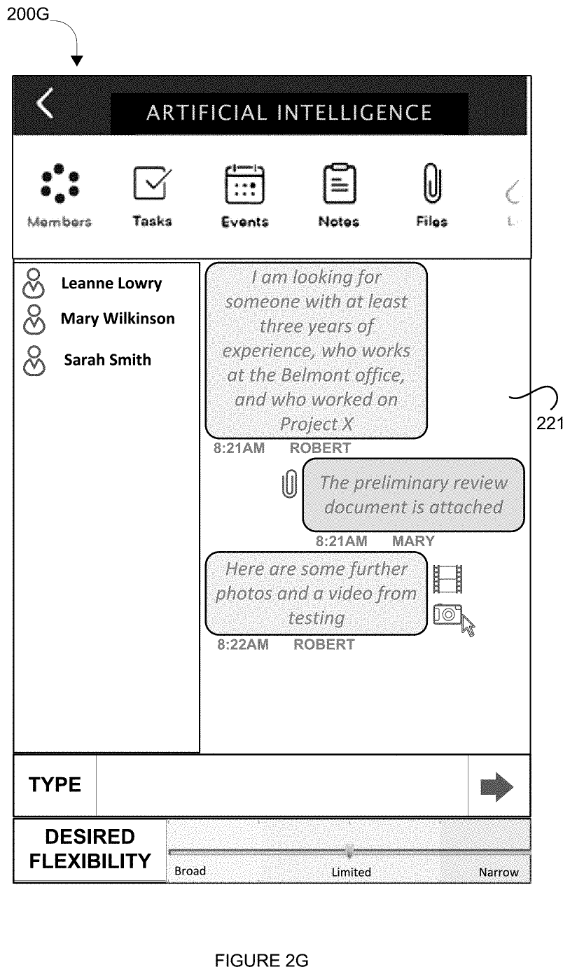

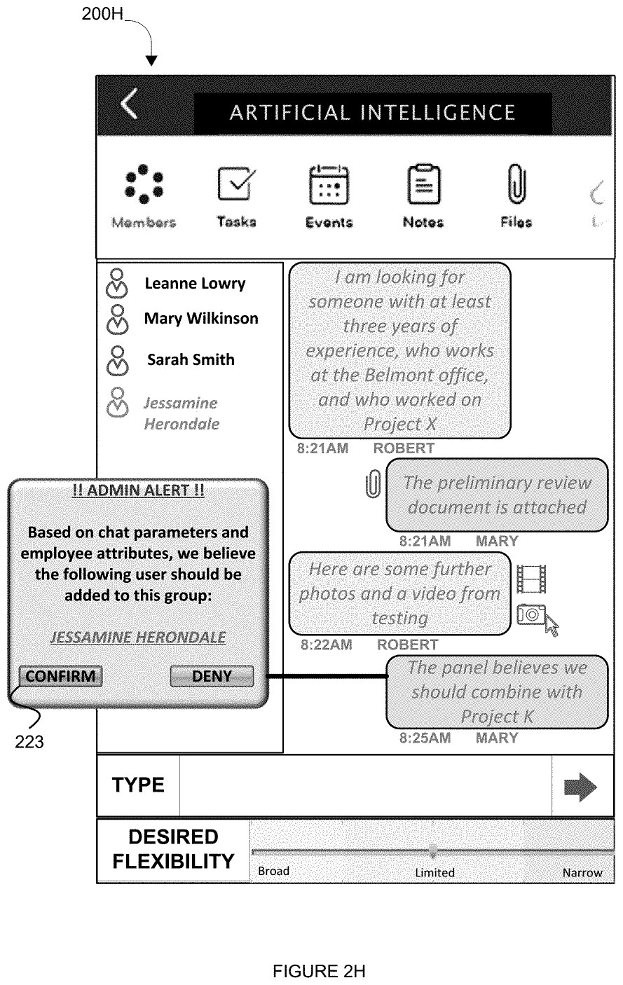

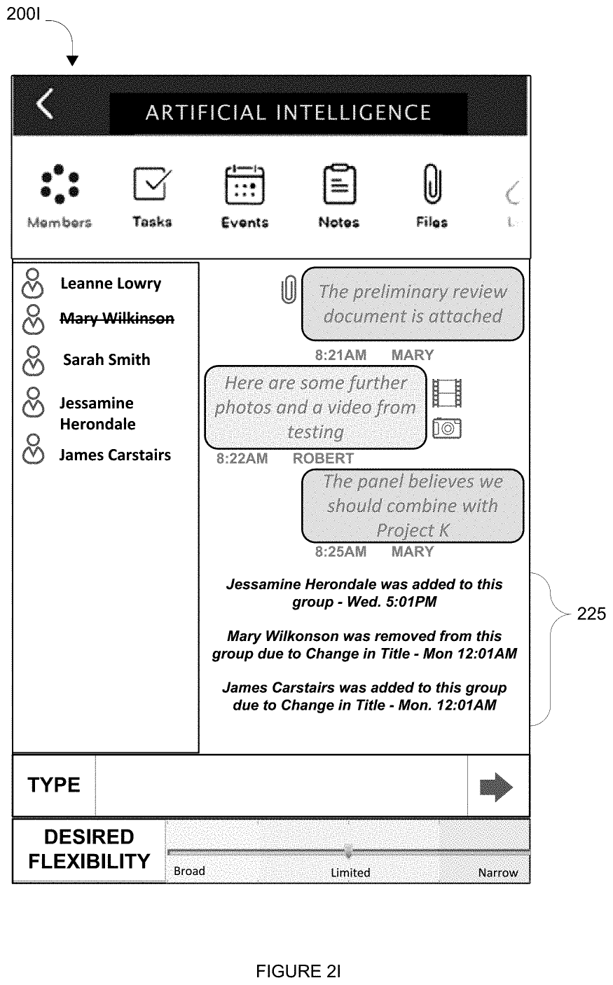

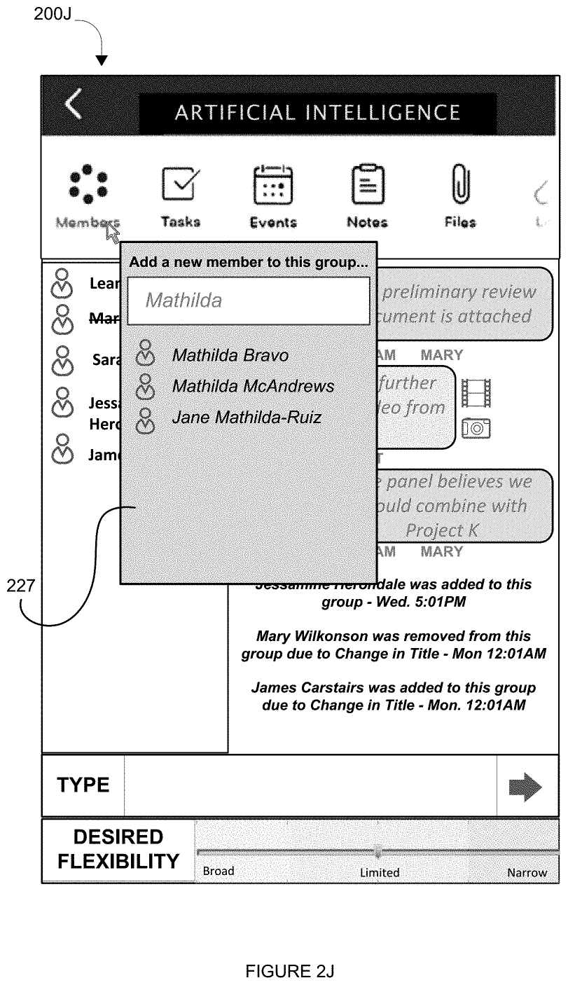

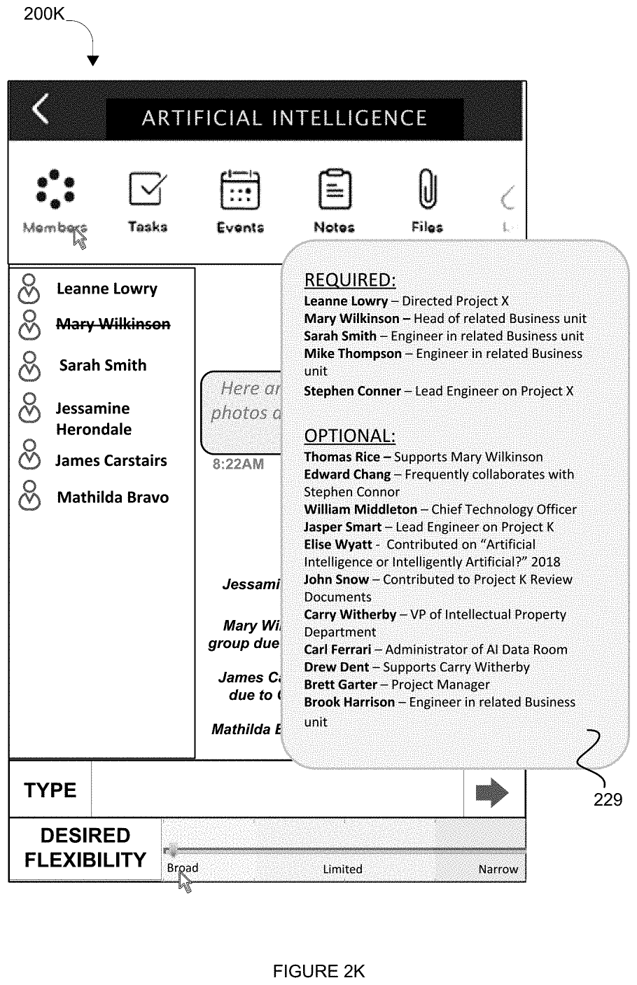

FIG. 2A shows a diagram illustrating an example of GUI 200A in accordance with some embodiments for creating online chat teams. As shown by GUI 200A, an online chat organizer or administrator may select the “+” icon 101 in order to create online chats teams. Selection of the “+” icon 101 or hovering over it may present a dropdown menu 103 to the organizer. In this instance “Create Team” icon 105 may be displayed and selection and/or hovering over the “Create Team” icon 105 may present additional icons for selection to the organizer. For example, selection of “Manual” icon enables the team to be created and for participants to be selected from a contact list. Additionally, a team may be created by selecting “By Subject” icon where the organizer can type a subject matter of interest, e.g., artificial intelligence (AI), machine learning, etc., and based on the subject matter the system, e.g., processor, can resolve that information against a database storing information regarding potential participants, e.g., employees of an organization, and to add the appropriate participants automatically and/or present them to the organizer for selection thereof. According to some embodiments, the processor may compare the received information through the GUIs to a database storing information (i.e. attributes) regarding the employees of the organization.

In some embodiments, a team may be created by selecting a “By Query” icon where the organizer can type a query (i.e. freeform expression), e.g., typing a sentence, any free form expression such as freeform expression used in a search engine, etc. The query may be resolved by the system, e.g., processor, against a database storing information regarding potential participants' attributes.

In some embodiments, a team may be created by selecting a “By Logical Expression” icon where the organizer can type a logical rule, formulas, etc., e.g., (Location=Belmont AND Background=AI), etc. The logical expression may be resolved by the system, e.g., processor, against a database storing information regarding potential participants' attributes.

It is appreciated that creating an online chat may also occur based on a selection of a combination of the above icons. For example, in some embodiments participants may be invited via a contact list in addition to by subject matter. In some of the embodiments an online chat may be created by selecting the subject matter icon as well as by conducting a query.

FIG. 2B shows a diagram illustrating an example of a GUI 200B where an online chat is created using a query. In this example, the GUI 200B enables the organizer to enter a query 201, e.g., “I am looking for someone with at least three years of experience, who works at the Belmont office, and who worked on Project X”. A processor may receive the query of the online chat via the GUI 200B. The received query 201 is resolved by the processor against a database as described above. In some embodiments, the online chat may be accompanied by selection of participants, tasks, events, notes, files, etc. as displayed on top of the screen. In some embodiments, flexibility scale 109 (hereinafter referred to and displayed as “Desired Flexibility”) associated with the query may be modified. For example, broadening the desired flexibility 109, hence increasing it, results in expansion of the query and as a result more results (i.e. participants). On the other hand, narrowing the desired flexibility 109, hence decreasing it, results in a more concise identification of the participants, thereby producing fewer results. In some embodiments, the flexibility 109 may be selected as “limited” by default, which is neither narrow nor broad.

FIG. 2C shows a diagram illustrating an example of a GUI 200C where results, as determined by the processor, are rendered 211 on a display device. In some example of the embodiments, the processor has resolved the query, in this instance “I am looking for someone with at least three years of experience, who works at the Belmont office, and who worked on Project X”, with a Limited flexibility against a database. The processor may display the results 211. For example, in some GUIs the processor may display 211 the “Required” participants and it may further display the “Optional” participants. In this example, the “Required” participants are Leanne Lowry based on past projects (Directed Project X), Mary Wilkinson based on her title (Head of related Business Unit), Sarah Smith based on her role (Engineer in related Business Unit), Mike Thompson based on his role (Engineer in related Business Unit), and Stephen Conner based on his role (Lead Engineer on Project X). In this example, the “Optional” participants are Thomas Rice based on his support role (Supports Mary Wilkinson), Edward Chang based on his collaborations (Frequently collaborates with Stephen Connor), and William Middleton based on his title (Chief Technology Officer). It is appreciated that the results may be displayed for the organizer selection thereof. In some embodiments, the selection may be made automatically by the system. Moreover, it is appreciated that at any point the desired flexibility 109 may be changed in order to broaden or narrow the scope and hence the results. For example, FIG. 2D shows a diagram illustrating an example of a GUI 200D where the desired flexibility 109 is changed to narrow the scope and as a result fewer participants are suggested 213. In this example, the optional participants are dropped. As presented above, flexibility scale can be coupled with ranking rate for each of the options with which the chat was created. For example, when a chat is created with the subject matter AI, the system will search for all participants related to the subject matter. It may have a ranking table with 5 columns containing “education specialization”, “background experience”, “work experience”, “past & present projects” and “hobbies”. When flexibility scale is in middle position the system searches for participants with 3 “yes”. When broadening the flexibility scale the system searches all participants with one “yes”, and when narrowing the flexibility scale only participants with all 5 “yes” are shown in the results. In other embodiments each of the plurality of columns may be ranked with “importance” value, for example columns “work experience” and “past & present projects” can be ranked with high importance “education specialization” and “background experience” with middle importance and “hobbies” with low importance. For each position of the flexibility scale the system can search for participants relevant to the subject matter including “importance” value. When the flexibility scale is in the middle position it can search for participants with 3 “yes” only, with “yes” related to columns with middle and/or high “importance”. When broadening the flexibility scale it is possible for participants with “yes” ranked with low “importance” to be shown in the results. When narrowing the flexibility scale the system may show only participants with 4 “yes” but ranked as middle and high importance or can show only participants with 2 “yes” ranked with high “importance”.

FIG. 2E shows a diagram illustrating an example of a GUI 200E where the desired flexibility 109 is changed to “Limited” and therefore displays the same results as the one shown in FIG. 2C. In this example, hovering or selection of the displayed results may provide additional information 215 regarding the required participants. For example, in this GUI hovering or selecting Sarah Smith provides additional information 215 such as her title, her supervisor's name, and further information that she has not delegated tasks and that her general response time is 8 hours. It is appreciated that the information that is provided may be from resolving the information received from the organizer against a database and complementing it with additional information through means such as machine learning, artificial intelligence, etc. For example, in some embodiments, the system may suggest Mary Wilkinson as a participant based on Sarah Smith's reporting structure to Mary.

FIG. 2F shows a diagram illustrating an example of a GUI 200F where additional information 217 regarding the result is further displayed. In this example, additional information 217 regarding Sarah Smith is displayed by displaying her business unit, title, work site, supervisor, telephone number, facsimile number, email address, previous projects, publications, etc. It is appreciated that each participant may further have a desired flexibility 219 associated therewith. For example, Sarah Smith may have desired flexibility 219 associated with her. Thus, narrowing the desired flexibility 219 for Sarah may indicate to the system that she has more of the factors that are desired for the online chat. On the other hand, broadening the desired flexibility 219 for Sarah may indicate to the system that she has fewer of the factors that are desired for the online chat. Thus, the system may further provide more potential participants like Sarah in response to the desired flexibility 219 being broader and vice versa. Similarly, other potential participants, e.g., Leanne Lowry, Mary Wilkinson, Mike Thompson, Stephen Connor, Thomas Rice, Edward Chang, and William Middleton, etc. may also have a desired flexibility 219 associated therewith where changes to their respective desired flexibility 219 results in more candidates or fewer candidates.

FIG. 2G shows a diagram illustrating an example of a GUI 200G where an online chat 221 among the participants has been created. Conversation 221 among the participants may start and continue. It is appreciated that any information such as a file, a picture, a video clip, etc. may be shared.

According to some embodiments, the processor may set permissions for participants of the team. For example, the processor may set permissions such that some team participants are allowed to replace participants when one participant has left or changed position with a new participant who has taken that participant's place or to add a new participant if it appears that a new employee fits the online chat criteria. Similarly, the processor may set permissions such that some team participants are allowed to add certain kinds of content to the team (e.g., files, links, notes, events, tasks, etc.) while other team participants are not. These permissions may be based on default settings, options received from an organizer initiating creation of the team or from other team participants, or the like.

The formation of a team may allow for exchanging of group messages within the team. The formation of an online chat may allow for tasks and events to be created and distributed to team participants. For example, as used herein, an “event” refers to a title or name associated with an occurrence date (e.g., “Team Meeting” scheduled to occur on May 31, 2016), and a “task” refers to a title or name associated with a due date (e.g., “Legal Memo” due on Jun. 6, 2017). A task or event may be associated with a single participant, with a conversation (that is, a group of messages) between participants, or with a team having a plurality of team participants (also referred to as participants). Furthermore, the formation of an online chat may allow for notes, files, links, etc., to be created and distributed to and/or collaboratively edited by team participants.

It is appreciated that the system, e.g., a processor, may track the chat conversation and manage the participants based on the factors, e.g., logical expressions, queries, subject matter, etc., that the chat was created and/or the manner in which the conversation has evolved. For example, FIG. 2H shows a diagram illustrating an example of a GUI 200H that depicts how the system has identified additional participants 223, e.g., Jessamine Herondale, based on the evolution of the conversation. In some embodiments, the participant may be added automatically and in some embodiments the system may present the option of adding the participant to the chat organizer. It is appreciated that the system may similarly determine that a participant is no longer needed and either automatically remove that participant or present the option of removing that participant to the chat organizer or other participants.

It is appreciated that the participants may automatically be managed as the projects and/or products change. In some embodiments, the system tracks the participants of the organization and their behavior and anything related to the participants attributes. Based on those changes, the system proposes a change in participants of the online chat or automatically updates the participants of the online chat. In other words, the participants of the online chat adapts and changes based on the evolution of the organization over time as changes occur to their product line, projects, and goals as well as their employees, their expertise, their background, their experience, etc.

FIG. 2I shows a diagram illustrating an example of GUI 200I that shows changes 225 made to the participants of the online chat based on changes associated with participants as well as nonparticipants of the online chat. For example, Jessamine Herondale was added to the group by selecting her, as was suggested in FIG. 2H. Mary Wilkonson in contrast was removed from the group because of a change in her title and James Carstairs was added due to change in his title.

FIG. 2J shows a diagram illustrating an example of GUI 200J that shows the ability to add new participants by selecting participants from a contact list 227. In other words, selection from a contact list 227 can complement participants that are added through other means, e.g., subject matter, query, logical expression, etc. It is appreciated that new participants, whether added using a contact list 227 or other means, may be added at any time, e.g., at the time of creating the online chat, subsequent to creation of the online chat, subsequent to chats among the online chat participants, etc. It is further appreciated that new participants may be discovered and added by manipulating the desired flexibility. For example, FIG. 2K shows a diagram illustrating an example of GUI 200K that shows the broadening of the desired flexibility 109 according to some embodiments. For example, broadening the desired flexibility may result 229 in more optional participants being presented, as shown. It is also appreciated that the broadening may also present more “Required” participants for selection thereof or for automatic addition thereof (not shown).

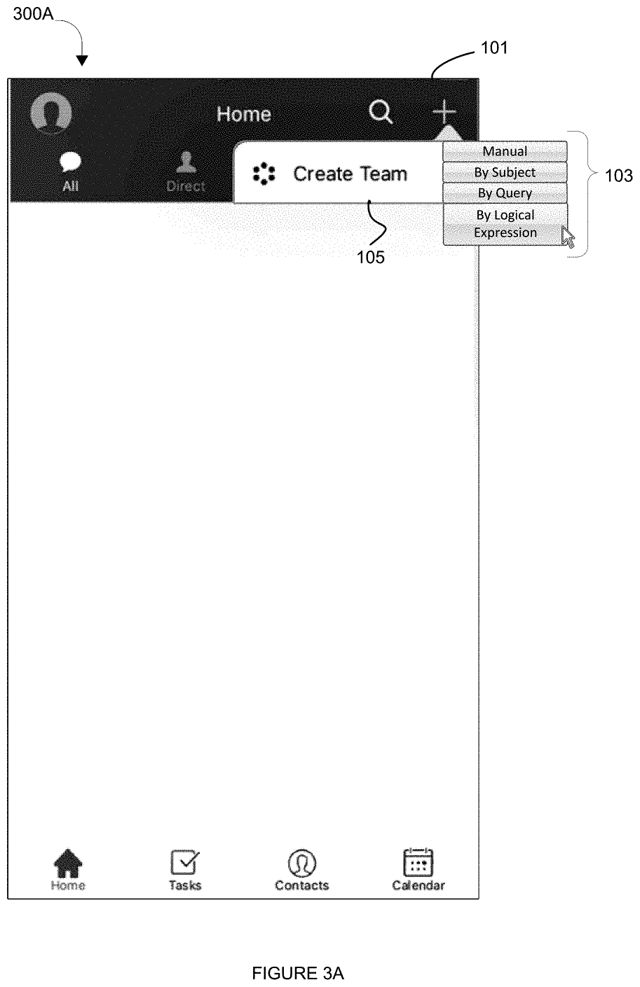

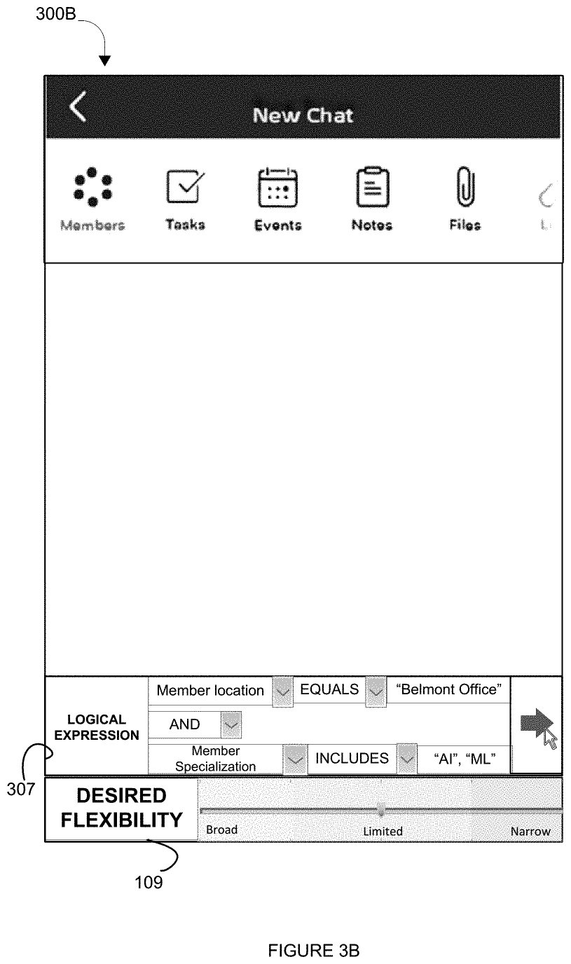

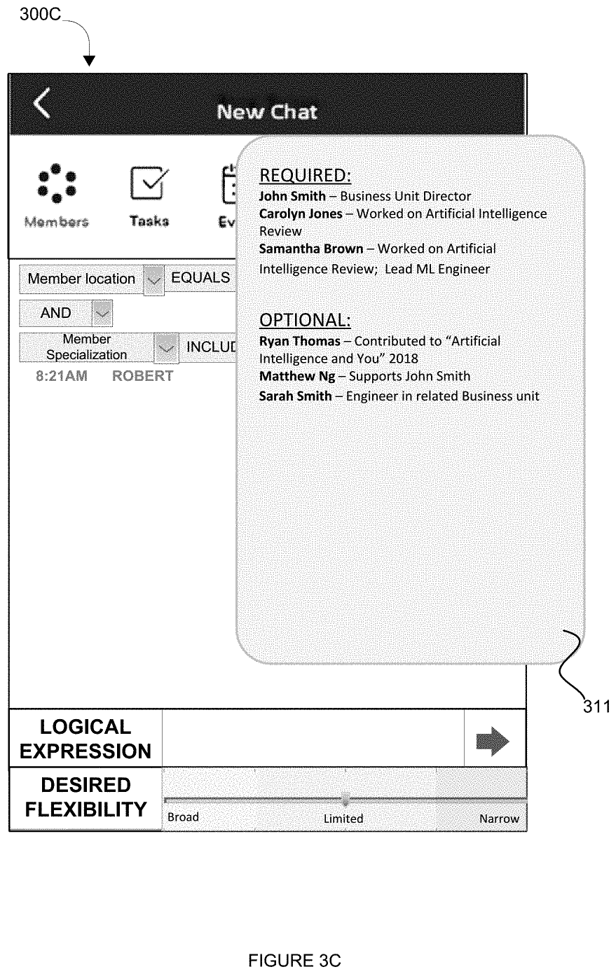

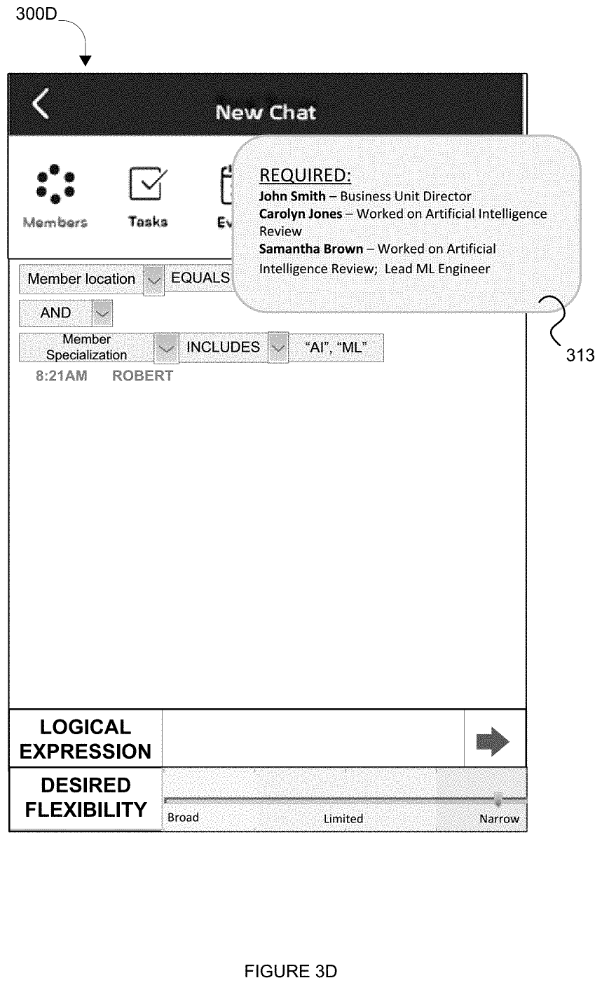

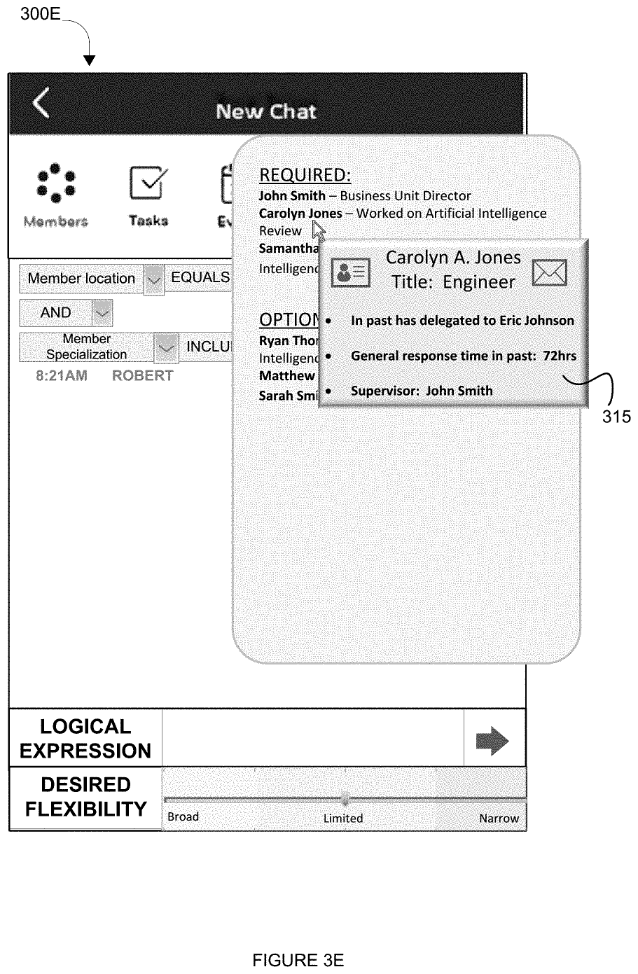

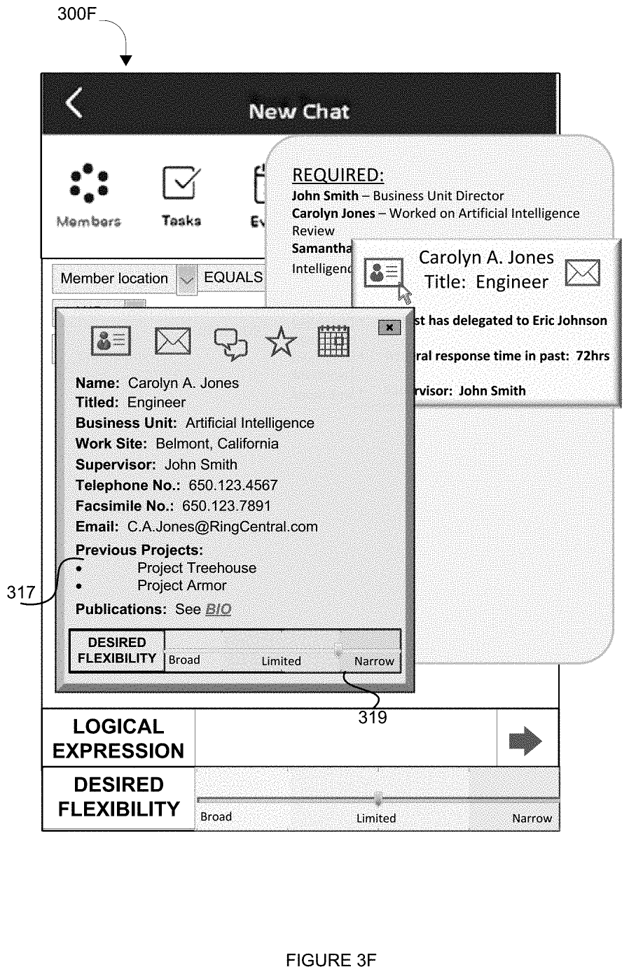

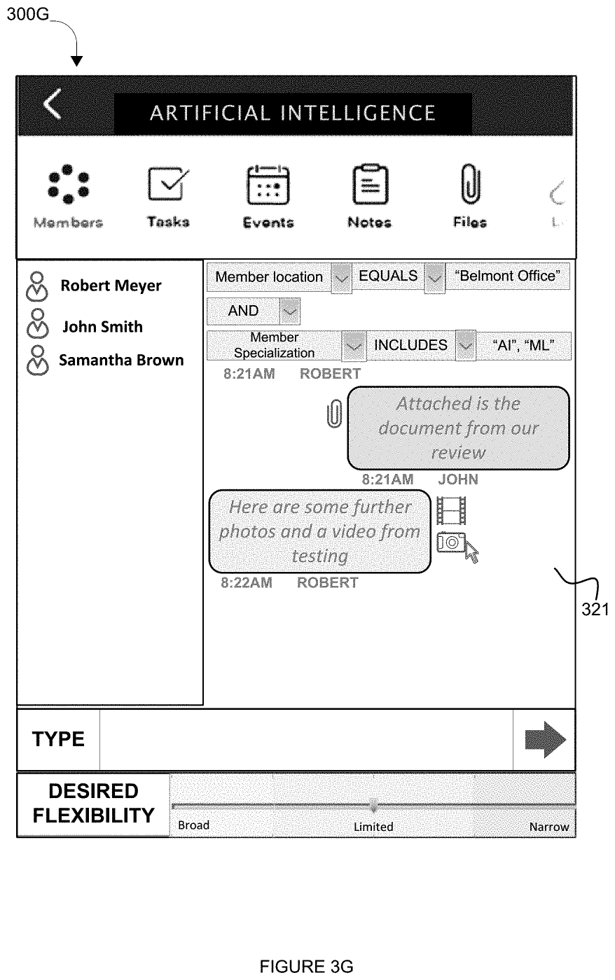

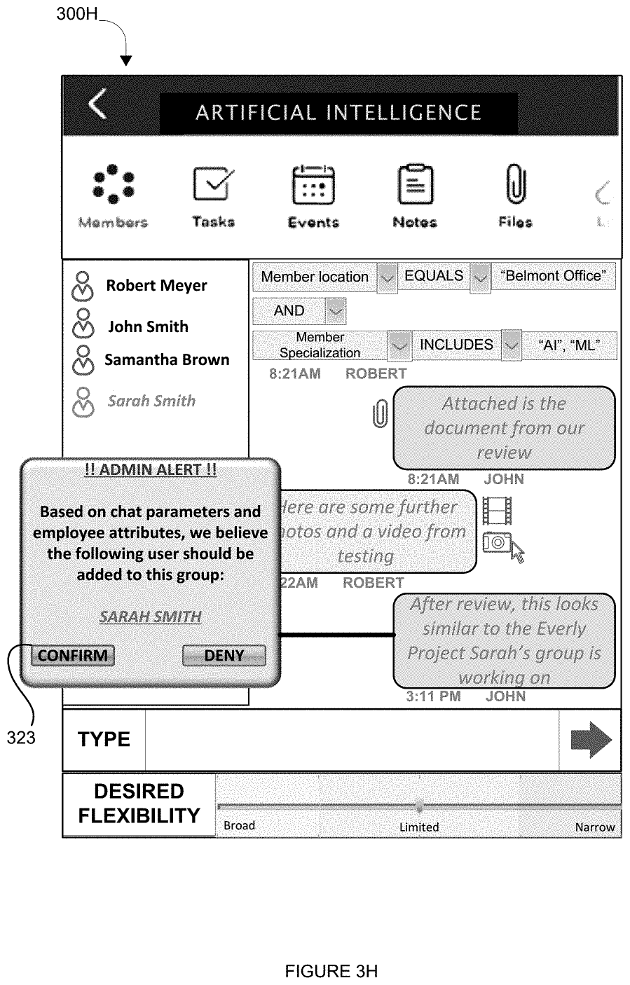

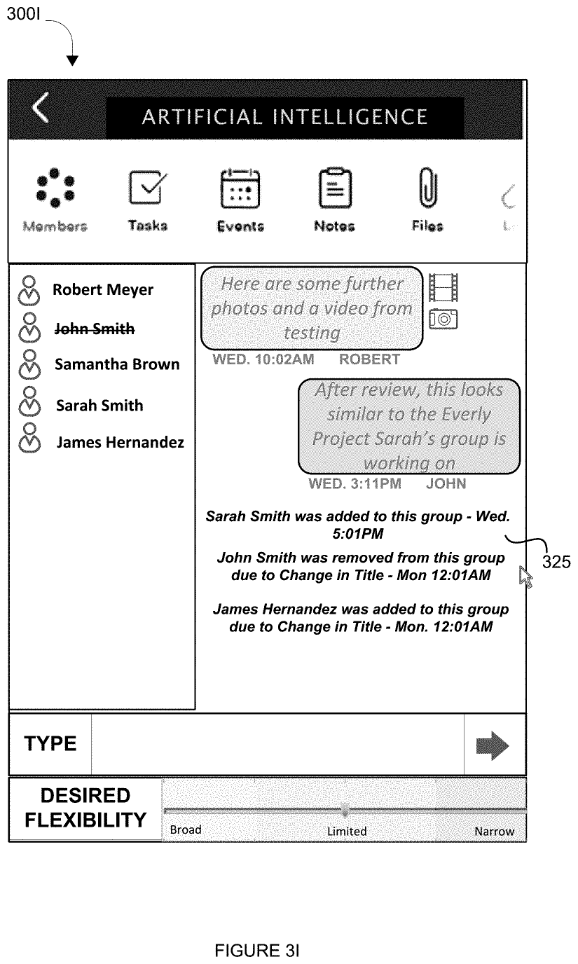

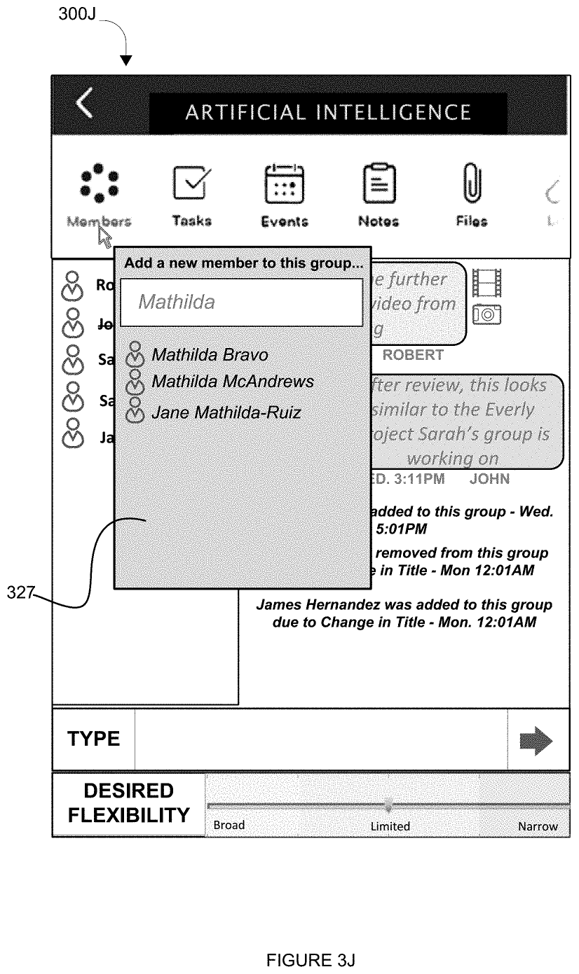

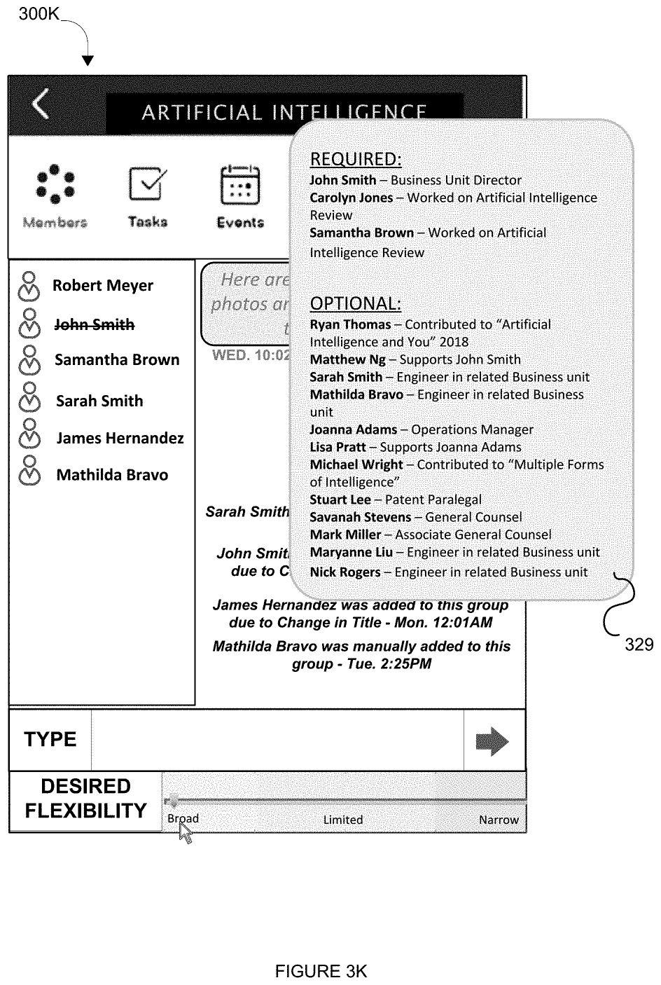

FIG. 3A shows a diagram illustrating an example of GUI 300A in accordance with some embodiments for creating online chat teams. As shown by GUI 300A, an online chat organizer or administrator may select the “+” icon 101 in order to create online chats teams. Selection of the “+” icon 101 or hovering over it may present a dropdown menu 103 to the organizer. In this instance “Create Team” icon 105 may be displayed and selection and/or hovering over the “Create Team” icon 105 may present additional icons for selection to the organizer. For example, selection of “Manual” icon enables the team to be created and for participants to be selected from a contact list. Additionally, a team may be created by selecting “By Subject” icon where the organizer can type a subject matter of interest, e.g., artificial intelligence (AI), machine learning, etc., and based on the subject matter the system, e.g., processor, can resolve that information against a database storing information regarding potential participants' attributes.

In some embodiments, a team may be created by selecting a “By Query” icon where the organizer can type a query (i.e. freeform expression), e.g., typing a sentence, any free form expression such as freeform expression used in a search engine, etc. The query may be resolved by the system, e.g., processor, against a database storing information regarding potential participants' attributes.

In some embodiments, a team may be created by selecting a “By Logical Expression” icon where the organizer can type a logical rule, formulas, etc., e.g., (Location=Belmont AND Background=AI), etc. The logical expression may be resolved by the system, e.g., processor, against a database storing information regarding potential participants' attributes.

It is appreciated that creating an online chat may also occur based on a selection of a combination of the above icons. For example, in some embodiments participants may be invited to join the online chat via a contact list in addition to by subject matter. In some embodiments, an online chat may be created by selecting the subject matter icon as well as by conducting a query.

FIG. 3B shows a diagram illustrating an example of a GUI 300B where an online chat is created using a logical expression 307. In this example, the GUI 300B enables the organizer to enter a logical expression 307, e.g., Participant Location=Belmont Office AND Participant Specialization Includes AI and Machine Learning (ML). A processor may receive the logical expression 307 of the online chat via the GUI 300B. The received logical expression 307 is resolved by the processor against a database as described above. In some embodiments, the online chat may be accompanied by selection of participants, tasks, events, notes, files, etc. as displayed on top of the screen. In some embodiments, flexibility scale 109 (hereinafter referred to and displayed as “Desired Flexibility”) associated with the query may be modified. For example, broadening the desired flexibility 109, hence increasing it, results in expansion of the logical expression 307 and as a result more results (i.e. participants). In other words, a looser, less strict, more relaxed enforcement of the expression, such that results with a lower match score produced be executing the expression against them would be included in the result set. On the other hand, narrowing the desired flexibility 109, hence decreasing it, results in a more concise identification of the participants, thereby producing fewer results. In some embodiments, the flexibility 109 may be selected as “limited” by default which is neither narrow nor broad.

Flexibility scale can be coupled with ranking rate for each of the options with which the chat was created. For example, when a chat is created with the subject matter AI, the system will search for all participants related to the subject matter. It may have a ranking table with 5 columns containing “education specialization”, “background experience”, “work experience”, “past & present projects” and “hobbies”. When flexibility scale is in middle position the system searches for participants with 3 “yes”. When broadening the flexibility scale the system searches all participants with one “yes”, and when narrowing the flexibility scale only participants with all 5 “yes” are shown in the results. In other embodiments each of the plurality of columns may be ranked with “importance” value, for example columns “work experience” and “past & present projects” can be ranked with high importance “education specialization” and “background experience” with middle importance and “hobbies” with low importance. For each position of the flexibility scale the system can search for participants relevant to the subject matter including “importance” value. When the flexibility scale is in the middle position it can search for participants with 3 “yes” only, with “yes” related to columns with middle and/or high “importance”. When broadening the flexibility scale it is possible for participants with “yes” ranked with low “importance” to be shown in the results. When narrowing the flexibility scale the system may show only participants with 4 “yes” but ranked as middle and high importance or can show only participants with 2 “yes” ranked with high “importance”.

FIG. 3C shows a diagram illustrating an example of a GUI 300C where results, as determined by the processor, are rendered on a display device. In one example of the embodiments, the processor has resolved the logical expression, with a Limited flexibility against a database. The processor may display the results 311. For example, in some GUIs the processor may display the “Required” participants and it may further display the “Optional” participants. In this example, the “Required” participants are John Smith based on his title (Business Unit Director), Carolyn Jones based on her previous work experience (Worked on Artificial Intelligence Review), and Samantha Brown based on her previous work experience (Worked on Artificial Intelligence Review, Lean ML engineer). In this example, the “Optional” participants are Ryan Thomas based on his contribution (Contributed to Artificial Intelligence and You” 2018), Mathew Ng based on his role (Support John Smith), and Sarah Smith based on her role (Engineer in related Business Unit). It is appreciated that the results may be displayed for the organizer selection thereof. In some embodiments, the selection may be made automatically by the system. Moreover, it is appreciated that at any point the desired flexibility 109 may be changed in order to broaden or narrow the scope and hence the results. For example, FIG. 3D shows a diagram illustrating an example of a GUI 300D where the desired flexibility 109 is changed to narrow the scope and as a result fewer participants are suggested 313. In this example, the optional participants are dropped.

FIG. 3E shows a diagram illustrating an example of a GUI 300E where the desired flexibility 109 is changed to “Limited” and therefore displays the same results as the one shown in FIG. 3C. In this example, hovering or selection of the displayed results may provide additional information 315 regarding the required participants. For example, in this GUI hovering or selecting Carolyn Jones provides additional information 315 such as her title, her supervisor's name, and further information that she has delegated tasks to Eric Johnson and that her general response time is 72 hours. It is appreciated that the information that is provided may be from resolving the information received from the organizer against a database and complementing it with additional information through means such as machine learning, artificial intelligence, etc. In some embodiments, the system may suggest John Smith as a participant based on Carolyn Jones' reporting structure to John. Moreover, in some embodiments the system may suggest Eric Johnson as a participant based on Carolyn's previous delegations to Eric.

FIG. 3F shows a diagram illustrating an example of a GUI 300F where additional information 317 regarding the result is further displayed. In this example, additional information 317 regarding Carolyn Jones is displayed by displaying her business unit, title, work site, supervisor, telephone number, facsimile number, email address, previous projects, publications, etc. It is appreciated that each participant may further have a desired flexibility 319 associated therewith. For example, Carolyn Jones may have desired flexibility 319 associated with her. Thus, narrowing the desired flexibility 319 for Carolyn may indicate to the system that she has more of the factors that are desired for the online chat. On the other hand, broadening the desired flexibility 319 for Carolyn may indicate to the system that she has fewer of the factors that are desired for the online chat. Thus, the system may further provide more potential participants like Carolyn in response to the desired flexibility 319 being broader and vice versa. Similarly, other potential participants, e.g., John Smith, Samantha Brown, Ryan Thomas, Matthew Ng, and Sarah Smith, etc. may also have a desired flexibility 319 associated therewith where changes to their respective desired flexibility 319 results in more candidates or fewer candidates.

FIG. 3G shows a diagram illustrating an example of a GUI 300G where an online chat 321 among the participants has been created. Conversation among the participants may start and continue. It is appreciated that any information such as a file, a picture, a video clip, etc. may be shared.

According to some embodiments, the processor may set permissions for participants of the team. For example, the processor may set permissions such that some team participants are allowed to replace participants when one participant has left or changed position with a new participant who has taken that participant's place or to add a new participant if it appears that a new employee fits the online chat criteria. Similarly, the processor may set permissions such that some team participants are allowed to add certain kinds of content to the team (e.g., files, links, notes, events, tasks, etc.) while other team participants are not. These permissions may be based on default settings, options received from an organizer initiating creation of the team or from other team participants, or the like.

The formation of a team may allow for exchanging of group messages within the team. The formation of an online chat may allow for tasks and events to be created and distributed to team participants. For example, as used herein, an “event” refers to a title or name associated with an occurrence date (e.g., “Team Meeting” scheduled to occur on May 31, 2016), and a “task” refers to a title or name associated with a due date (e.g., “Legal Memo” due on Jun. 6, 2017). A task or event may be associated with a single participant, with a conversation (that is, a group of messages) between participants, or with a team having a plurality of team participants (also referred to as participants). Furthermore, the formation of an online chat may allow for notes, files, links, etc., to be created and distributed to and/or collaboratively edited by team participants.

It is appreciated that the system, e.g., a processor, may track the chat conversation and manage the participants based on the factors, e.g., logical expression, queries, subject matter, etc., according to which the chat was created and/or the manner in which the conversation has evolved. For example, FIG. 3H shows a diagram illustrating an example of a GUI 300H that depicts how the system has identified additional participants 323, e.g., Sarah Smith, based on the evolution of the conversation. In some embodiments, the participant may be added automatically and in some embodiments the system may present the option of adding the participant to the chat organizer. It is appreciated that the system may similarly determine that a participant is no longer needed and either automatically remove that participant or present the option of removing that participant to the chat organizer or other participants.

It is appreciated that the participants may automatically be managed as the projects and/or products change. In some embodiments, the system tracks the participants of the organization and their behavior and anything related to the participants' attributes. Based on those changes, the system proposes a change in participants of the online chat or automatically updates the participants of the online chat. In other words, the participants of the online chat adapts and changes based on the evolution of the organization over time as changes occur to their product line, projects, and goals as well as their employees, their expertise, their background, their experience, etc.

FIG. 3I shows a diagram illustrating an example of GUI 3001 that shows changes 325 made to the participants of the online chat based on changes associated with participants as well as nonparticipants of the online chat. For example, Sarah Smith was added to the group by selecting her, as was suggested in FIG. 3H. John Smith in contrast was removed from the group because of a change in her title and James Hernandez was added due to change in his title.

FIG. 3J shows a diagram illustrating an example of GUI 300J that shows the ability to add new participants by selecting participants from a contact list 327. In other words, selection from a contact list 327 can complement participants that are added through other means, e.g., subject matter, query, logical expression, etc. It is appreciated that new participants, whether added using a contact list 327 or other means, may be added at any time, e.g., at the time of creating the online chat, subsequent to creation of the online chat, subsequent to chats among the online chat participants, etc. It is further appreciated that new participants may be discovered and added by manipulating the desired flexibility. For example, FIG. 3K shows a diagram illustrating an example of GUI 300K that shows the broadening of the desired flexibility 109 according to some embodiments. For example, broadening the desired flexibility 109 may result in more optional participants being presented 329, as shown. It is also appreciated that the broadening may also present more “Required” participants for selection thereof or for automatic addition thereof (not shown).

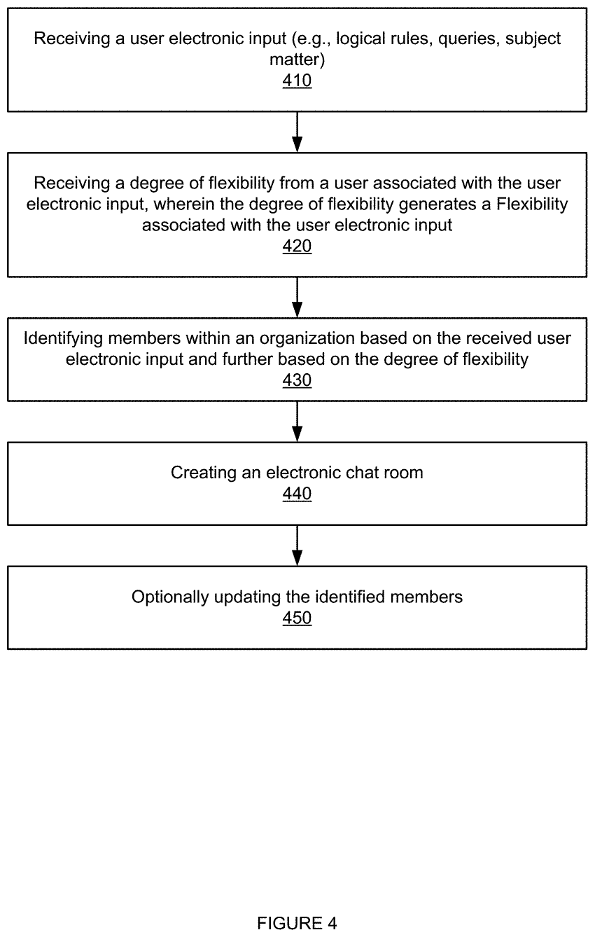

FIG. 4 shows a flow chart illustrating an example of method flow for creating online chats in accordance with some embodiments. At step 410, an organizer electronic input, e.g., logical rules, queries, subject matter, etc., is received, e.g., via a GUI. It is appreciated that the organizer electronic input may be a combination or sub-combination of logical rules, queries, subject matter, etc. At step 420, a degree of flexibility (also referred to as flexibility above) associated with the organizer electronic input is received, e.g., via a GUI. At step 430, participants of an organization are identified based on the electronic organizer input and further based on the degree of flexibility associated therewith. For example, a processor may resolve the received electronic organizer input and the flexibility associated therewith against a database to identify potential participants to be added to form an electronic chat room. The identifying may be based on various information associated with the participants' attributes. It is appreciated that according to some embodiments the received information may be complemented with data derived through other means, e.g., machine learning, artificial intelligence, etc.

At step 440, an electronic chat room that includes a subset of the identified participants is created. For example, a processor may form an electronic chat room based on a subset of the participants that are identified. At step 450, the identified participants within the organization are optionally updated over time. Accordingly, as the organization evolves, e.g., conversation of the chat room changes, product line changes, title of the employees change, employees are hired and leave, etc., the participants of the electronic chat room evolve as well. It is appreciated that in some embodiments, the participants of the chat room are updated, either automatically by the system, e.g., processor, or presented to the chat organizer for selection thereof, based on the updated identified participants. It is appreciated that in some embodiments, the update is based on the content of the conversation within the created online chat room and in some embodiments, it is based on changes within the organization, e.g., title changes, project changes, changes to participants of a group within an organization, etc.

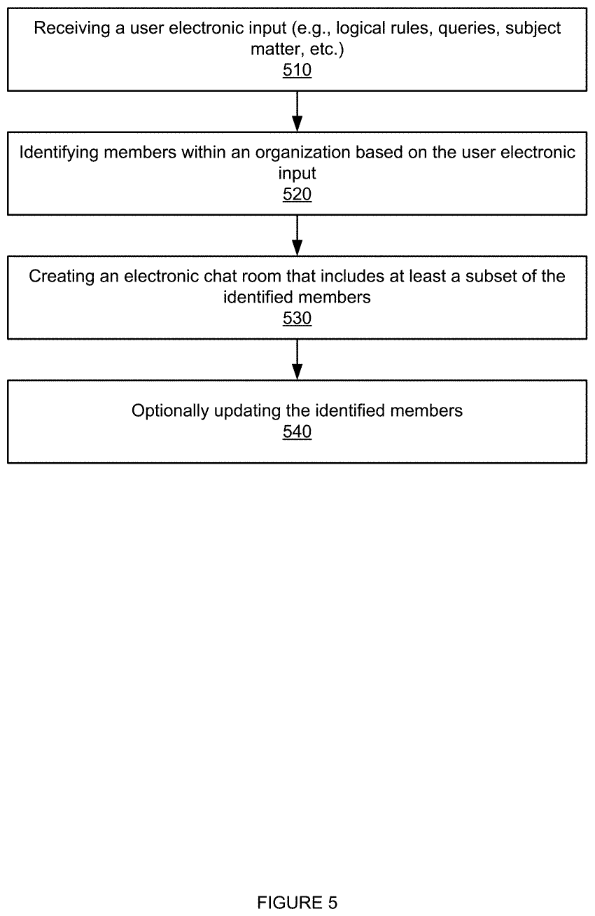

FIG. 5 shows another flow chart illustrating an example of method flow for creating online chats in accordance with some embodiments. At step 510, an organizer electronic input, e.g., logical rules, queries, subject matter, etc., is received, e.g., via a GUI. It is appreciated that the organizer electronic input may be a combination or sub-combination of logical rules, queries, subject matter, etc. At step 520, participants of an organization are identified based on the electronic organizer input. For example, a processor may resolve the received electronic organizer input against a database to identify potential participants' attributes. It is appreciated that according to some embodiments the received information may be complemented with data derived through other means, e.g., machine learning, artificial intelligence, etc. It is further appreciated that according to some embodiments the received information may be derived through means such as machine learning, artificial intelligence, etc.

At step 530, an electronic chat room that includes a subset of the identified participants is created. For example, a processor may form an electronic chat room based on a subset of the participants that are identified. At step 540, the identified participants within the organization are optionally updated over time. Accordingly, as the organization evolves, e.g., conversation of the chat room changes, product line changes, title of the employees change, employees are hired and leave, etc., the participants of the electronic chat room evolve as well. It is appreciated that in some embodiments, the participants of the chat room are updated, either automatically by the system, e.g., processor, or presented to the chat organizer for selection thereof, based on the updated identified participants. It is appreciated that in some embodiments, the update is based on the content of the conversation within the created online chat room and in some embodiments, it is based on changes within the organization, e.g., title changes, project changes, changes to participants of a group within an organization, etc.

Accordingly, the system allows chat teams to be created where the participant composition of the teams is defined using a combination of rules, queries, subject matter, etc., that the system resolves against a current set of organization participants in order to resolve a set of real participants for the team. Thus, team participants can dynamically change over time and adapt to organization changes, participant changes, and discussion changes.

In one example according to some embodiments, the system allows chat teams to be created for participants belonging to a department of an organization. For example, a chat team can be created where the participant set is defined as being all organization participants whose employee profiles indicate that they work in the finance department. As new employees join the organization to work in the finance department, their employee profiles would be entered by the HR department staff into the employee management/recordkeeping system, and a field in the employee profiles would indicate their assignment to the finance department. By virtue of the logical team definition in the collaboration system, and by virtue of an integration between the collaboration system and the employee management/recordkeeping system, any new employees in the finance department are automatically added as participants of the finance chat team in the collaboration system.

Similarly, if a finance department employee is later reassigned from the finance department to the legal department, then the updating of their employee profile by the HR staff to account for their change in department assignment would result in the disclosed system automatically removing them from the finance chat team to which they were originally automatically added. It is appreciated that the disclosed system may automatically add them to any other chat teams whose participant sets are defined using logical terms involving rules and queries that, when resolved by the system, would include the employee in the participants result set, such as a chat team defined as being for all employees of the legal department. It is appreciated that if an employee leaves the organization, online chat is updated and the employee is removed.

In one example according to some embodiments, a chat team can be created based on interests. Interests may be work related, such as an interest in AI, Machine Learning, Continuous Deployment, React Framework, Responsive Design, Regional Taxation Policies, Data Security, Privacy, etc. In some examples, interests may be related to personal life, such as an interest in hiking, kayaking, running, yoga, skiing, live jazz, poker, fine dining, etc. A chat team may be created with an explicitly declared topic of interest and automatically selected. In some embodiments, the team participants may dynamically change as the participants of an organization change. This may be determined from information about them available from their employee profiles in the employee management/recordkeeping system of the organization, as well as other sources of information about them, such as their online profiles on social networks or their communications through different communication platforms (e.g. email).

In one example, a chat team can be created where the participant set is defined as being all organization participants whose employee profile indicates that they have an interest in AI and ML technologies, as represented by tags or keywords in the “interests” field of their profiles. The organization participants interested in AI and ML may be spread widely throughout the organization. For example, participants of the sales and marketing departments interested in ways to use AI and ML to help them research leads or more effectively market to prospects may use the created chat team to discuss this with other participants interested in applying AI and ML in their respective areas. In some examples, participants of the operations organization interested in ways to use AI and ML to identify inefficient patterns in operations for optimization may use the created chat team to discuss this with other participants interested in applying AI and ML in their respective areas. Once created, the chat team will be populated automatically by the system with all those organization participants who would be interested in sharing thoughts and perspectives on the topic, thereby encouraging synergies within the organization.

Furthermore, as new employees join the organization who also express their interest in this topic, when they fill out their employee profile, may also be automatically added to the chat team. In addition, as employees who had expressed their interest in the topic leave the organization, the system would automatically remove them from the chat team. Similarly, participants of the organization who had not previously expressed an interest in the topic, but who later update their employee profile to express their interest, by adding relevant tags or keywords to the “interests” field of their profile, may be automatically added to the chat team by the system. In other words, the system may automatically update the chat team by managing them and by adding/removing team participants or by presenting those updates to the chat administrator to make the necessary changes. In contrast, participants of the organization who had previously expressed an interest in the topic, but who later update their employee profile to express that they no longer have an interest in the topic, by removing relevant tags or keywords from the “interests” field of their profile, may be automatically removed from the chat team by the system. Accordingly, the system may automatically remove participants from the chat team or present the update to the chat organizer to take the necessary steps.

In some examples according to some embodiments, the system allows chat teams to have flexibility built in. For example, chat teams may be created with a fuzzy boundary. In other words, the system may automatically involve other participants of the organization in the discussions of the team as the system sees fit. Participants of the organization who are not defined as being participants of the chat team—either as explicitly specified individual participants, or as individual participants of a group of real participants that has been resolved from a logical participant—may be notified of messages in the chat team that the system deems relevant to them, or that the system deems they should be made aware of.

The organizer of a chat team may enable the fuzzy boundary behavior for a team, e.g., by adjusting the desired flexibility as presented above. When a chat team has been defined to employ the fuzzy boundary behavior, outside participants may be notified about messages as needed, but the system may also suggest participants to be added as the discussions within the team develop over time. In some embodiments, participants outside of a particular organization or within the organization is identified as the online chat participants are identified by resolving the query, logical expression, subject matter, etc., against a database, as discussed above. The system may employ AI and ML in order to identify additional participants within the organization or outside of the organization that may need to be added.

In some examples according to some embodiments, a chat team may be created as a private team and also include a defined fuzzy boundary behavior. As a result, the system may recommend to the team organizer or admin to selectively forward certain messages to outside participants or even participants of the organization. Accordingly, the system may suggest modifications to be made to the team, e.g., adding new participants, based upon the flexibility, based upon the participants, based upon changes within the organization, based upon the evolution of the conversation within the chat room, etc.

In one example according to some embodiments, the system allows chat teams to be created, where there are no participants—explicit or logical—that are declared, and where there is no discussion topic declared. Such chat teams may be defined by only a name (e.g. “Company Open Forum”, “The Watercooler”, etc.) and may not have a description associated therewith.

For example, an online chat team may be created by the name of “Oracle of Acme Corporation” that is intended to allow any of the employees of the company to submit their comments, feedback, questions, concerns, etc. The system may employ AI and/or ML to determine how to direct messages to the appropriate participants of the organization. As such, messages can be brought to the attention of the appropriate participants and responded to accordingly without bothering all the other participants of the organization for whom such messages may not be of interest.

The online chat team may enable a feature allowing the participants to respond in a chat team to just a participant who posted a message. The system may employ such a capability to allow responses to be directed privately to participants who posted a message. The system may also employ a feature allowing chat teams to contain nested private chats involving a subset of the parent chat team's participants in order to follow up responses to messages.

In one example according to some embodiments, the system enables online chat teams to be created by explicit selection of participants, e.g., from a contact list, along with selection of participants via subject matter, logical expression, queries, etc. The system may then resolve the received input against a current set of organization participants to create the online chat team. For example, a chat team may be created by a group of engineers to discuss a proposed implementation for a software component that needs to operate with the Personally Identifying Information (PII) of customers while ensuring security and privacy for those customers. The organizer of the chat team may wish to involve a suitable participant of the security organization in the discussion, in a consulting/advisory capacity. The employees working in the security organization may maintain tags or keywords in their employee profile records indicating whether they serve in the role of technical liaison to other groups or departments in the company. The organizer of the chat team, without knowing anything about the current composition of the security organization, may add as a participant of the new chat team the logical participant “security organization technical liaison”, and the system of the disclosure will resolve this logical participant to a real participant (or participants) as appropriate based upon the current—and potentially changing over time—composition of the security organization. As a result, a suitable number of representatives within the security organization can be engaged regarding the security-impacting aspects of the discussions conducted within the chat team.

In one example according to some embodiments, a logical participant (as may be embodied in or represented by a logical expression/query) is evaluated against all the available teams and participants. The system thus produces a result set that can be then sorted and sub-sorted by columns/properties, and from which a finite (e.g., just one, the first three, the top ten, etc.) or an unbounded subset of the result set can be selected as participants. For example, a chat team may be created by the CTO for setting the tone for an engineering organization of a company, by communicating with the key thought leaders and influencers in the organization. The CTO may add, as participants of the chat team, the logical participants: VP of Engineering, Engineering Directors, Architects, Dev Leads. While the logical participant “VP of Engineering” would resolve to a single real participant, the logical participants “Engineering Directors”, “Architects”, and “Development Leads” would likely each resolve to more than one real participant, particularly as the engineering organization grows with the business. Eventually there may be many engineering directors, architects, and development leads, working on a multitude of projects, and potentially in different offices spread across multiple geographical regions that may be included as part of the team that has been created.

In an embodiment where a logical participant of a chat team resolves to a collective of real participants, the system may provide the participants of the chat team an ability to address their messages directly to the logical participant/collective participant by their logical participant identity, thereby directing their message to the group rather than to individual participants of the group. For example, the CTO may choose to address a motivational/inspirational message directly to the “Dev Leads” who are leading the teams of developers performing the actual day-to-day development work that is critical to the success of the engineering organization. The CTO may achieve this by starting the message using a syntactical construct supported by the chat system for mentioning or referring to participants, such as in the example message “@Dev Leads, great job on rallying your teams to hit our very challenging release deadline this quarter. You guys rock!”. Similarly, an individual participant of the “Dev Leads” collective participant may address a message to the “Engineering Directors” logical participant to raise an issue relating to planning process inefficiencies that is causing frustration or churn for the development teams, such as in the example message “@Engineering Directors, please help us to deal with these ongoing issues with last minute feature requests from the product managers.”

The system may also permit messages to be addressed directly to individual participants of a group of real participants that has been resolved from a logical participant. For example, the message from the individual participant of the “Dev Leads” collective participant that was addressed to the “Engineering Directors” logical participant can be responded to by one of the individual participants of the “Engineering Directors” collective participant. The response can be addressed directly to the individual participant of the “Dev Leads” collective participant, using that individual participant's user name. Furthermore, the individual participants of a group of real participants that have been resolved from a logical participant can be populated into the set of participants that is used by the auto-suggest mechanism that is employed when an organizer starts typing a user name using an @mention or similar such syntactical construct supported by the chat system. Thus, the system can allow any participant of a chat team containing logical participants to address messages directly to individual real participants that would be resolved from any of the logical participants of the chat team, by addressing those individual participants directly by their individual user names.

In one example according to some embodiments, the system updates the participant composition of a chat team automatically to account for changes in a participant's status in the organization. The update may also occur for participants that have been selected explicitly, e.g., through a contact list. As such, if responsibilities of an employee are assumed by a different employee, or where an employee leaves the organization, or where an employee is assigned to a completely different department, the team participants for the chat are updated. In other words, whenever there is a change for a participant or for an organization, the suitability of that participant may be impacted for the purposes of the online chat team. Thus, the system determines which of those chat teams would be affected by the change and either automatically makes the appropriate changes or presents the appropriate changes to the chat organizer so that the organizer can make the appropriate changes, if desired. For example, if a participant leaves the company, the system may determine that for a personal, non-work related chat, e.g., on the topic of wine tasting, between that participant and other participants, there is no need to automatically update the chat team's participants by adding a new participant to substitute for the departed participant. On the other hand, if the departed participant was involved in a chat with other participants about an important technical matter regarding a project where the departed participant's responsibilities will be assumed by a new employee, then the system may automatically update that technical chat team's participants by adding the new employee as a substitute for the departed participant. As a result, any new questions or posts on the matter of the team's discussions can be seen, and potentially responded to, by the new employee. In general, the system might substitute participants for chat teams where a departed employee was active and provided answers, advice, feedback, or comments on work related matters, or where they received technical knowledge relating to their job function or area of responsibility within the organization.

In one example according to some embodiments, the system may not make changes in the participant composition of affected chat teams automatically. Instead, the system may transmit such participant impact events to the chat/collaboration service affected, which events may be relayed to and handled by agents of the various chat teams. Thus, each team can tailor their approach in making any changes to the chat team, based on their needs. In some embodiments, the handling logic employed by agents of the chat teams may be expressed through configurable rules that are evaluated by the agents against received participant impact events, in order for the agents to decide any changes in participants of their associated teams.

In one example according to some embodiments, the affected teams may be configurable to handle participant impact events in a variety of ways. For example, chat teams may automatically accept a substitute suggested by the disclosed system, or may activate an agent to obtain a suitable substitute, or they may ignore or merely be informed by any substitute suggested by the disclosed system, or they may inform participants of the team of the impact through a system message posted to the chat, or they may inform just selective participants of the team (e.g. chat team admins or hosts) of the impact through private messages. In some examples, chat teams may request from the unaffected participants of a team to propose substitute candidates in order to replace the defunct participants, etc. Furthermore, a chat team may be configured to require review and approval of proposed team participant changes by the chat team administrator/organizer before being accepted. In the event that a defunct participant has one or more special roles within an affected chat team, e.g., online chat organizer/administrator, team owner, team admin, team moderator, etc., the special roles can be handed over to one or more remaining non-defunct participants of the team.

In one example according to some embodiments, changes made to the online chat participants are announced to the participants of the affected teams. For example, when a company employee departs, a message to this effect may be issued to all the chat teams in which they had been a participant. If such a defunct participant is to be represented by a substitute participant, then the addition of the new participant, and the fact of them being added for the purpose of representing the departed employee may be expressed in a message issued to the teams affected in this way.

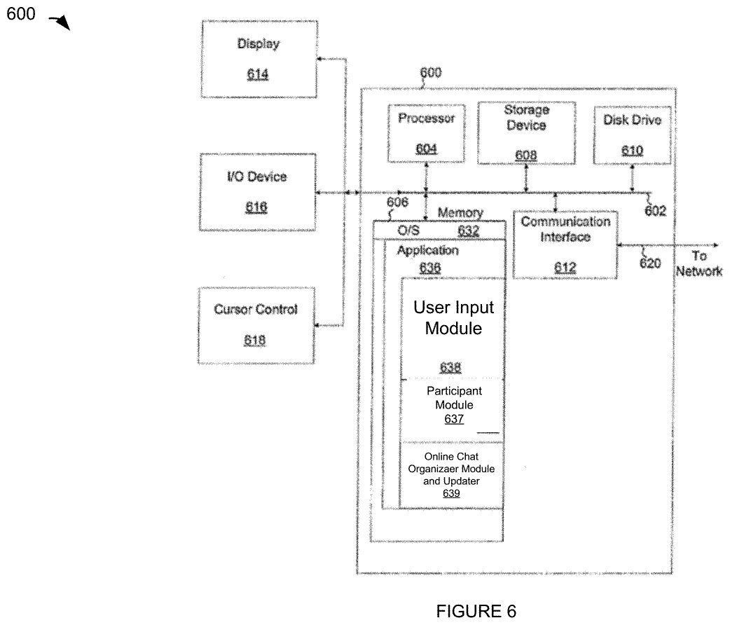

Referring now to FIG. 6, an exemplary block diagram of a computer system suitable for creating online chat rooms in accordance with some embodiments is shown. In some examples, computer system 600 can be used to implement computer programs, applications, methods, processes, or other software to perform the above-described techniques and to realize the structures described herein. Computer system 600 includes a bus 602 or other communication mechanism for communicating information, which interconnects subsystems and devices, such as a processor 604, a system memory (“memory”) 606, a storage device 608 (e.g., ROM), a disk drive 610 (e.g., magnetic or optical), a communication interface 612 (e.g., modem or Ethernet card), a display 614 (e.g., CRT or LCD), an input device 616 (e.g., keyboard), and a pointer cursor control 618 (e.g., mouse or trackball). In one embodiment, pointer cursor control 618 invokes one or more commands that, at least in part, modify the rules stored, for example in memory 606, to define the electronic message preview process.

According to some examples, computer system 600 performs specific operations in which processor 604 executes one or more sequences of one or more instructions stored in system memory 606. Such instructions can be read into system memory 606 from another computer readable medium, such as static storage device 608 or disk drive 610. In some examples, hard-wired circuitry can be used in place of or in combination with software instructions for implementation. In the example shown, system memory 606 includes modules of executable instructions for implementing an operation system (“O/S”) 632, an application 636 (e.g., a host, server, web services-based, distributed (i.e., enterprise) application programming interface (“API”), program, procedure or others). Further, application 636 includes a module of executable instructions for receiving user input module 638 that receives user input such as subject matter, query, logical expression, etc., as well as modules of executable instructions for identifying participant module 637 to identify potential participants of an online chat room and an online chat organizer module and updater 639 that creates an online chat and manages the participants of the online chat room. It is appreciated that participants are identified and managed by receiving relevant information, e.g., AI, ML, user input, etc., and resolving the received information against a database that contains data associated with potential participants, e.g., employees of an organization, etc. in order to identify the participants to be invited and to be managed.

The term “computer readable medium” refers, at least in one embodiment, to any medium that participates in providing instructions to processor 604 for execution. Such a medium can take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 600. According to some examples, two or more computer systems 600 coupled by communication link 620 (e.g., LAN, PSTN, or wireless network) can perform the sequence of instructions in coordination with one another. Computer system 600 can transmit and receive messages, data, and instructions, including program code (i.e., application code) through communication link 620 and communication interface 612. Received program code can be executed by processor 604 as it is received, and/or stored in disk drive 610, or other non-volatile storage for later execution. In one embodiment, system 600 is implemented as a hand-held device. But in other embodiments, system 600 can be implemented as a personal computer (i.e., a desktop computer) or any other computing device. In at least one embodiment, any of the above-described delivery systems can be implemented as a single system 600 or can implemented in a distributed architecture including multiple systems 600.

In view of the foregoing, examples of previewing a shared screen are described. Screen sharing systems can be implemented using real-time interfaces that are configured to control and manage communication dynamically over an IP network. Further electronic messaging systems can be implemented on computer readable medium using the modules as described above to preview screen sharing content. The described techniques can be used to emulate other electronic messaging technologies by receiving messages with generated message preview independent of content storing.

In other examples, the systems, as described above can be implemented from a personal computer, a computing device, a mobile device, a mobile telephone, a facsimile device, a personal digital assistant (“PDA”) or other electronic device. Various embodiments can apply to any electronic screen sharing.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

1. A method comprising:
receiving an electronic user input, wherein the electronic user input is selected from a group consisting of logical rules, queries, and a subject matter;
receiving a degree of flexibility from a user via a graphical user interface (GUI), wherein the degree of flexibility is an indication of desired conciseness of the electronic user input;
identifying participants within an organization based on the received electronic user input and further based on the degree of flexibility; and
creating an online chat room that includes at least a subset of the identified participants.

2. The method as described in claim 1 further comprising updating the identified participants by adding or removing participants within the organization over time and further updating the participants of the subset of the identified participants of the online chat room, wherein the updating is responsive to content of conversation within the online chat room.

3. The method as described in claim 1 further comprising updating the identified participants within the organization over time, wherein the updating is responsive to changes within the organization.

4. The method as described in claim 3, wherein the changes are selected from a group consisting of changes to title, changes to projects, and changes to participants of a group within the organization.

5. The method as described in claim 4 further comprising updating participants of the subset of the identified participants within the online chat room responsive to the changes.

6. The method as described in claim 1, wherein the identifying comprises utilizing machine learning and artificial intelligence to identify the participants.

7. The method as described in claim 1, wherein the identifying is further based on participants of the organization's past projects, expertise, educational degree, department within the organization, title, and interest.

8. A method comprising:
receiving a user input, wherein the user input is selected from a group consisting of logical rules and queries;
identifying participants within an organization based on the user input; and
creating a chat room that includes at least a subset of the identified participants.

9. The method as described in claim 8 further comprising updating the identified participants within the organization over time and further updating the participants of the subset of the identified participants of the chat room, wherein the updating is responsive to content of conversation within the chat room.

10. The method as described in claim 8 further comprising updating the identified participants within the organization over time, wherein the updating is responsive to changes within the organization.

11. The method as described in claim 10, wherein the changes is selected from a group consisting of changes to title, changes to projects, and changes to participants of a group within the organization.

12. The method as described in claim 11 further comprising updating participants of the subset of the identified participants within the chat room responsive to the changes.

13. The method as described in claim 8, wherein the identifying comprises utilizing machine learning and artificial intelligence to identify the participants.

14. The method as described in claim 8, wherein the identifying is further based on participants of the organization's past projects, expertise, educational degree, department within the organization, title, and interest.

15. A method comprising:
receiving a user input, wherein the user input comprises a subject matter;
identifying participants within an organization based on the subject matter of the user input; and
creating a chat room that includes at least a subset of the identified participants.

16. The method as described in claim 15 further comprising updating the identified participants within the organization over time and further updating the participants of the subset of the identified participants of the chat room, wherein the updating is responsive to content of conversation within the chat room.

17. The method as described in claim 15 further comprising updating the identified participants within the organization over time, wherein the updating is responsive to changes within the organization.

18. The method as described in claim 17, wherein the changes is selected from a group consisting of changes to title, changes to projects, and changes to participants of a group within the organization.

19. The method as described in claim 18 further comprising updating participants of the subset of the identified participants within the chat room responsive to the changes.

20. The method as described in claim 15, wherein the identifying comprises utilizing machine learning and artificial intelligence to identify the participants.
